(19) United States
(12) Patent Application Publication
(10) Pub. No.: US 2025/0345152 A1
(43) Pub. Date: Nov. 13, 2025

(54) DENTAL APPLIANCES WITH AESTHETIC FEATURES

(71) Applicant: Align Technology, Inc., San Jose, CA (US)

(72) Inventors: Michael Christopher Cole, San Jose, CA (US); Ken Wu, San Jose, CA (US); John Michael Riedesel, San Jose, CA (US)

(21) Appl. No.: 19/203,728

(22) Filed: May 9, 2025

Related U.S. Application Data
(60) Provisional application No. 63/645,638, filed on May 10, 2024.

(51) Int. Cl. A61C 7/08

(52) U.S. Cl. CPC A61C 7/08

(57) ABSTRACT

Dental appliances with aesthetic features and associated methods and systems are provided. In some embodiments, a dental appliance includes a shell having a plurality of cavities, the shell configured to reposition a patient's teeth from a first tooth arrangement toward a second tooth arrangement. The dental appliance can also include a mask region integrally formed with the shell. The mask region can be configured to cover at least one tooth of the patient's teeth and can depict the at least one tooth according to a target tooth arrangement.

### CROSS-REFERENCE TO RELATED APPLICATION(S)

The present application claims the benefit of priority to U.S. Provisional Application No. 63/645,638, filed May 10, 2024, the disclosure of which is incorporated by reference herein in its entirety.

### TECHNICAL FIELD

The present technology generally relates to dental appliances, and in particular, to dental appliances with aesthetic features.

### BACKGROUND

Orthodontic procedures typically involve repositioning a patient's teeth to a desired arrangement in order to correct malocclusions and/or improve aesthetics. To achieve these objectives, dental appliances such as braces, shell aligners, and the like can be applied to the patient's teeth. The dental appliances are configured to exert force on one or more teeth in order to effect desired tooth movements. The application of force can be periodically adjusted by a practitioner (e.g., by altering the appliance or using different types of appliances) in order to incrementally reposition the teeth to a desired arrangement. In some instances, however, conventional dental appliances can have an unpleasant, obtrusive, or otherwise disagreeable appearance, potentially resulting in reduced patient comfort, self-confidence, and compliance. One such example is braces, which include prominent wires and brackets that can interfere with a patient's smile and aesthetic preferences. Moreover, some patients may be reluctant to use dental appliances due to limited customization options.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a front view of a dental appliance.

FIG. 1B is a top view of a portion of the dental appliance of FIG. 1A.

FIG. 1C is a front view of the dental appliance of FIG. 1A when worn by a patient.

FIG. 2A is a perspective view of a dental appliance with a mask region, in accordance with embodiments of the present technology.

FIG. 2B is a cross-sectional view of a portion of the dental appliance of FIG. 2A, in accordance with embodiments of the present technology.

FIG. 2C is a front view of the dental appliance of FIG. 2A, in accordance with embodiments of the present technology.

FIG. 2D is a top view of a portion of the dental appliance of FIG. 2A, in accordance with embodiments of the present technology.

FIG. 2E is a front view of a set of dental appliances worn by a patient, in accordance with embodiments of the present technology.

FIG. 3A is a cross-sectional view of a dental appliance with a mask region, in accordance with embodiments of the present technology.

FIG. 3B is a cross-sectional view of a dental appliance with a mask region, in accordance with embodiments of the present technology.

FIG. 4A is a front view of a dental appliance with colored interproximal portions, in accordance with embodiments of the present technology.

FIG. 4B is a front view of a dental appliance with deepened interproximal portions, in accordance with embodiments of the present technology.

FIG. 4C is a top view of the dental appliance of FIG. 4B, in accordance with embodiments of the present technology.

FIG. 5A is a perspective view of a dental model of a patient's teeth.

FIG. 5B is a perspective view of a nontransparent dental appliance without a mask region on the dental model.

FIG. 5C is a perspective view of a nontransparent dental appliance with a mask region on the dental model, in accordance with embodiments of the present technology.

FIG. 6A is a cross-sectional view of a dental appliance including a shell and a mask region for covering a buccal attachment, in accordance with embodiments of the present technology.

FIG. 6B is a cross-sectional view of a dental appliance including a shell and a mask region for covering a lingual attachment, in accordance with embodiments of the present technology.

FIG. 7 is a flow diagram illustrating a method for designing and fabricating a dental appliance, in accordance with embodiments of the present technology.

FIG. 8A is a cross-sectional illustration of a tooth.

FIG. 8B is an image of a cross-section of an actual tooth.

FIG. 9A is a front view of a dental appliance worn on a patient's teeth, in accordance with embodiments of the present technology.

FIG. 9B is a front view of a dental appliance worn on a patient's teeth, in accordance with embodiments of the present technology.

FIG. 9C is a front view of a set of dental appliances worn on a patient's teeth, in accordance with embodiments of the present technology.

FIGS. 10A-10C are photographs of colored dental appliances, in accordance with embodiments of the present technology.

FIG. 11A illustrates a representative example of a tooth repositioning appliance configured in accordance with embodiments of the present technology.

FIG. 11B illustrates a tooth repositioning system including a plurality of appliances, in accordance with embodiments of the present technology.

FIG. 11C illustrates a method of orthodontic treatment using a plurality of appliances, in accordance with embodiments of the present technology.

FIG. 12 illustrates a method for designing an orthodontic appliance, in accordance with embodiments of the present technology.

FIG. 13 illustrates a method for digitally planning an orthodontic treatment and/or design or fabrication of an appliance, in accordance with embodiments of the present technology.

FIG. 14 is a partially schematic diagram providing a general overview of an additive manufacturing process, in accordance with embodiments of the present technology.

### DETAILED DESCRIPTION

The dental appliances described herein, along with related systems and methods, can be employed as part of a treatment plan for a patient's teeth while also providing a desired aesthetic appearance. For example, such dental appliances can be configured to disguise the current arrangement of the patient's teeth (e.g., a maloccluded tooth arrangement) while also having features that more accurately mimic the appearance of natural teeth and/or desired tooth arrangements (e.g., a non-maloccluded tooth arrangement). In some embodiments, for example, a dental appliance can include a shell having a plurality of cavities, where the shell is configured to reposition a patient's teeth from a first tooth arrangement toward a second tooth arrangement. The dental appliance can also include a mask region integrally formed with the shell, where the mask region is configured to cover at least one anterior tooth of the patient's teeth, and where the mask region depicts the at least one anterior tooth in a target tooth arrangement.

Also provided herein are methods for digitally designing a dental appliance. The method can include receiving a treatment plan including a plurality of treatment stages, the plurality of treatment stages corresponding to a plurality of intermediate tooth arrangements for repositioning a patient's teeth. The method can further include receiving a digital representation of a target tooth arrangement for one or more teeth of the patient's teeth. The method can further include generating a digital representation of a dental appliance for implementing a treatment stage of the treatment plan, where the dental appliance includes a shell corresponding to the intermediate tooth arrangement of the treatment stage and a mask region corresponding to the target tooth arrangement. Moreover, the method can include generating instructions for fabricating the dental appliance based on the digital representation, wherein the instructions are configured to cause the mask region to be integrally formed with the shell.

The dental appliances and methods described herein can provide many advantages. Since the dental appliances can include a mask region corresponding to a target tooth arrangement, a patient wearing the dental appliance can adopt the look of the final or improved result of the target tooth arrangement at an initial and/or intermediate stage of treatment, as opposed to having to wait for all teeth to be repositioned before attaining the final or improved result. For example, the mask region can reflect the patient's dentition as it will appear when treatment has finished, which can improve the patient's confidence and/or treatment compliance. Furthermore, the mask region can allow a patient to get a preview of the final or improved result, which can be modified according to the patient's needs. Additionally, the dental appliances disclosed herein can be made of materials and/or have various aesthetic features that more accurately mimic the appearance of natural teeth, thus making it less apparent that the patient is wearing a dental appliance. The dental appliances can also be customized with aesthetic features such as sparkles, patterns, colors, and/or custom tooth shapes (e.g., costume teeth such as monster teeth). Furthermore, the dental appliances provided herein do not have to be transparent, allowing for a wider range of suitable materials than conventional dental appliances. The present technology allows for the combination of functional features, such as the repositioning of teeth, with aesthetic features, such as improved appearance.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

1. Dental Appliances with Aesthetic Features and Associated Methods

Dental appliances of the present technology can include features that provide a desired aesthetic appearance. In some embodiments, for example, a dental appliance (e.g., an aligner, retainer, palatal expander, mouth guard) has an appearance that mimics a desired tooth arrangement, such as a target (e.g., non-maloccluded arrangement) tooth arrangement to be achieved by a dental treatment plan. The dental appliance can be made of a material that is partially or fully nontransparent, thereby disguising the current arrangement of the patient's teeth to obscure aesthetically undesirable characteristics such as malocclusions, damaged teeth, missing teeth, stained teeth, tooth-mounted attachments, etc. Other aesthetic features that may alternatively or additionally be incorporated into the dental appliance include colors, shading, patterns, additives (e.g., glitter), etc. In some embodiments, the dental appliance is also configured to apply repositioning forces to one or more of the patient's teeth to implement the treatment plan, thus concurrently providing therapeutic and aesthetic benefits to the patient.

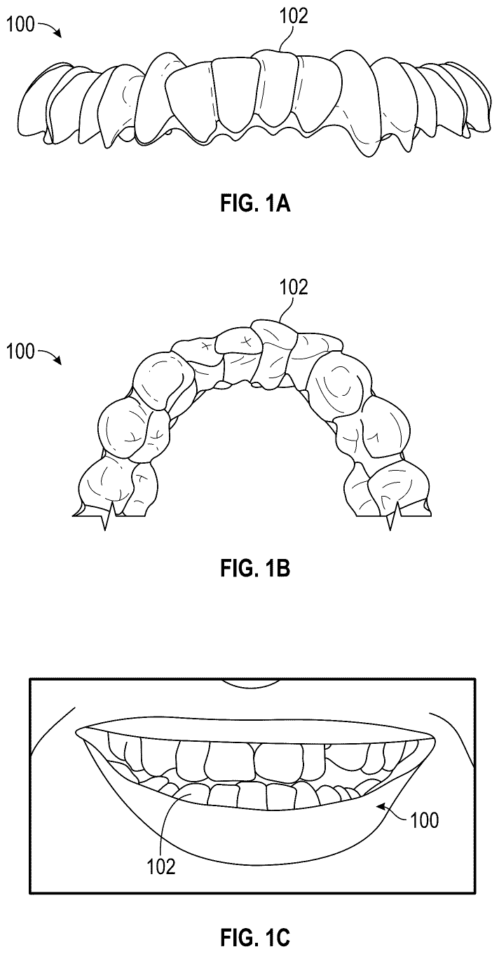

FIGS. 1A-1C illustrate an example of a dental appliance 100 that may be improved by incorporating one or more of the aesthetic features described herein. Specifically, FIG. 1A is a front view of the dental appliance 100, FIG. 1B is a top view of a portion of the dental appliance 100, and FIG. 1C is a front view of the dental appliance 100, when the dental appliance 100 is worn by a patient. Referring first to FIGS. 1A and 1B, the dental appliance 100 can include a shell 102 (e.g., a polymeric shell) having a plurality of cavities that receive and resiliently reposition one or more of the patient's teeth in accordance with a treatment stage of a treatment plan. Typically the shell 102 is partially or fully transparent, such that the patient's underlying teeth are visible when the dental appliance 100 is worn by the patient, e.g., as shown in FIG. 1C. Accordingly, in situations where the patient's current tooth arrangement is aesthetically undesirable, e.g., due to severe malocclusions, damaged teeth, missing teeth, stained teeth, presence of additional hardware (e.g., tooth-mounted attachments), etc., the dental appliance 100 may benefit from the addition of aesthetic features to disguise the current tooth arrangement and/or provide the appearance of corrected teeth.

a. Dental Appliances with M Ask Region

In some embodiments, the present technology provides dental appliances including a mask region configured to provide an aesthetic benefit, such as disguising one or more teeth in a patient's current tooth arrangement (e.g., teeth that are maloccluded, damaged, missing, include hardware coupled thereto, or are otherwise aesthetically undesirable). In some embodiments, the mask region can resemble a dentition with non-maloccluded and/or straight teeth, e.g., aligned anterior teeth that are mirrored about the midline. Alternatively, or in combination, the mask region can include colors, shading, and/or other aesthetic features that may correspond to a patient's desired aesthetic.

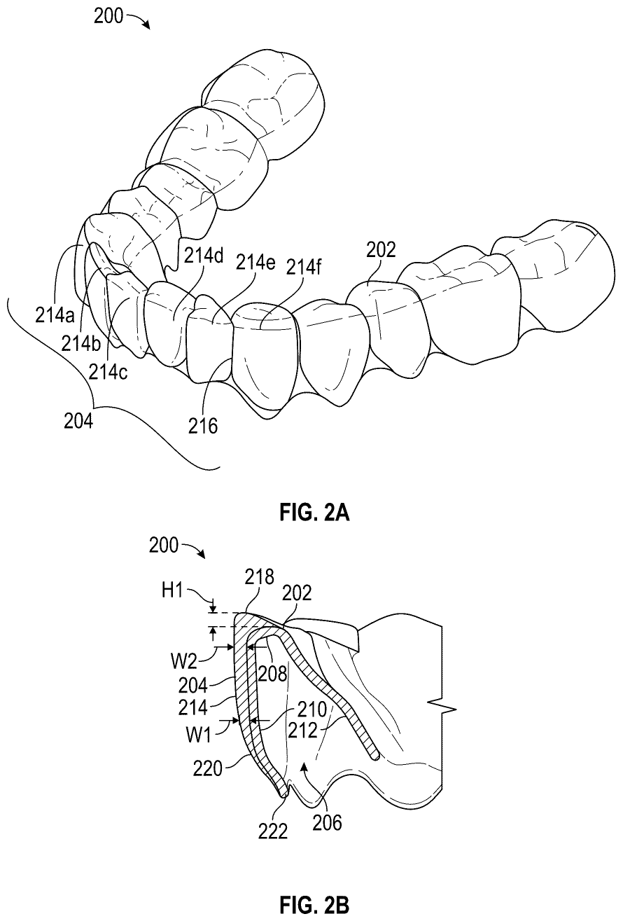

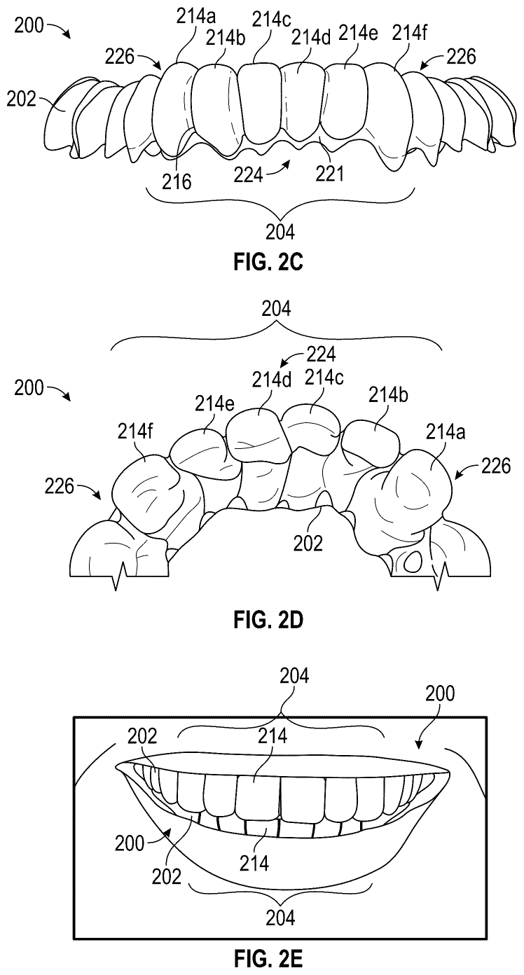

FIGS. 2A-2E illustrate an example of a dental appliance 200 including a mask region, in accordance with embodiments of the present technology. Specifically, FIG. 2A is a perspective view of the dental appliance 200, FIG. 2B is a cross-sectional view of a portion of the dental appliance 200, FIG. 2C is a front view of the dental appliance 200, FIG. 2D is a top view of a portion of the dental appliance 200, and FIG. 2E is a front view of a set of dental appliances 200 worn by a patient.

Referring first to FIG. 2A, the dental appliance 200 includes a shell 202 and a mask region 204 connected to the shell 202. The shell 202 can be configured to receive some or all of a patient's teeth and, optionally, apply one or more repositioning forces on the received teeth to move one or more teeth from a first tooth arrangement toward a second tooth arrangement. For example, the first tooth arrangement can be a current tooth arrangement of the patient's teeth, and the second tooth arrangement can be an intermediate or final tooth arrangement of a treatment plan for the patient's teeth. The shell 202 can include a plurality of cavities configured to receive and reposition one or more teeth toward the second tooth arrangement. In some embodiments, the shell 202 includes an occlusal wall, a buccal wall, and a lingual wall that surround and define the cavities. For example, as shown in FIG. 2B, cavity 206 is adjacent to and defined by occlusal wall 208, buccal wall 210, and lingual wall 212 of the shell 202.

The mask region 204 can be configured to provide an aesthetic benefit when the dental appliance 200 is worn by the patient, such as covering one or more of the patient's teeth that have an undesirable appearance. The mask region 204 can cover any suitable portion of the patient's teeth. For example, the mask region 204 may cover only a subset of the patient's teeth, such as only the anterior teeth (e.g., central incisors, lateral incisors, and/or canines), only the teeth that are visible when the patient smiles, only the teeth that are maloccluded, etc. Alternatively, the mask region 204 may cover all of the patient's teeth, including both anterior and posterior teeth. The mask region 204 can cover a tooth by covering a single surface of the tooth (e.g., the buccal surface only) or by covering multiple surfaces of the tooth (e.g., the occlusal surface, buccal surface, and/or lingual surface). Optionally, the mask region 204 can also cover other parts of the patient's intraoral cavity, such as the gingiva, palate, etc.

In some embodiments, the mask region 204 is integrally formed with the shell 202 as a single unitary component, such that the mask region 204 cannot be separated from the shell 202 without destroying the dental appliance 200. For example, the mask region 204 and shell 202 can be fabricated concurrently in the same manufacturing process (e.g., an additive manufacturing process or thermoforming process), as described further herein. Alternatively, the mask region 204 can be a separate component from the shell 202 and can be temporarily or permanently coupled to the shell 202, e.g., using adhesives, bonding elements, fasteners, snap fit, interference fit, etc.

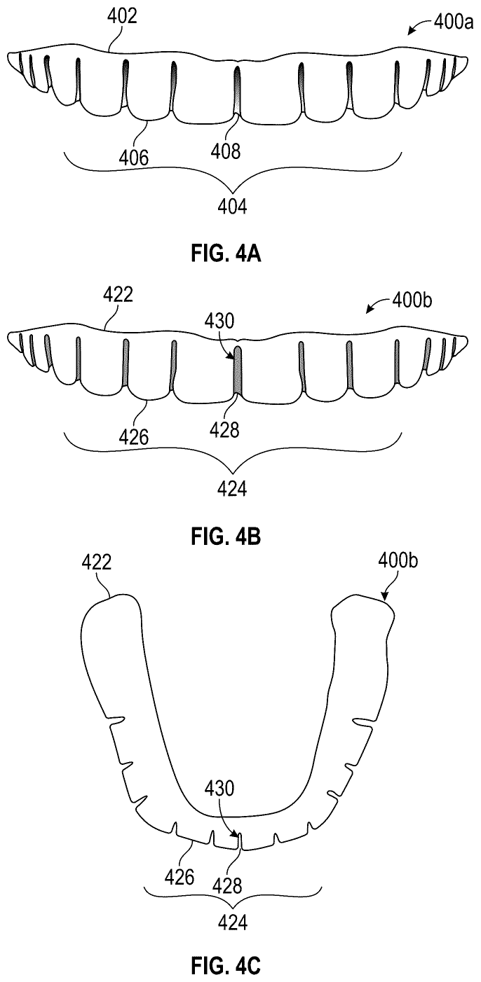

Referring to FIGS. 2A, 2C, and 2D together, in some embodiments, the mask region 204 includes one or more tooth masks (e.g., tooth masks 214a-214f-collectively, “tooth masks” 214). Each tooth mask 214 can cover a respective tooth and depict the tooth in a target tooth arrangement, such as a non-maloccluded arrangement to be achieved via the treatment plan (e.g., similar to the function of a pontic or veneer). The mask region 204 can further include one or more interproximal portions 216 between neighboring tooth masks 214. The interproximal portions 216 can mimic the appearance of the natural interproximal spaces between the patient's teeth. In some embodiments, the interproximal portions 216 are enhanced, e.g., as described further below in connection with FIGS. 4A-4C.

In some embodiments, each tooth mask 214 has the same or similar shape as the corresponding actual tooth of the patient (e.g., the buccal and/or occlusal surfaces of the tooth mask 214 have the same or similar topography as the buccal and/or occlusal surfaces of the corresponding tooth), but the tooth mask 214 is positioned according to the target (e.g., non-maloccluded) position for the tooth rather than the current (e.g., maloccluded) position of the tooth. The position of the tooth mask 214 may be the final desired tooth position or an intermediate tooth position (e.g., a tooth position that is one or more stages ahead of the position specified by the current treatment stage). Alternatively, the tooth mask 214 can have a different shape than the corresponding actual tooth, such as a generic tooth shape, an idealized tooth shape, an undamaged tooth shape, an artificial tooth shape (e.g., costume teeth), or other target tooth shape desired by the patient. Optionally, a tooth mask 214 can be used to disguise a missing tooth, e.g., the tooth mask 214 can have the appearance of a normal tooth and can occupy the gap in the dentition left by the missing tooth.

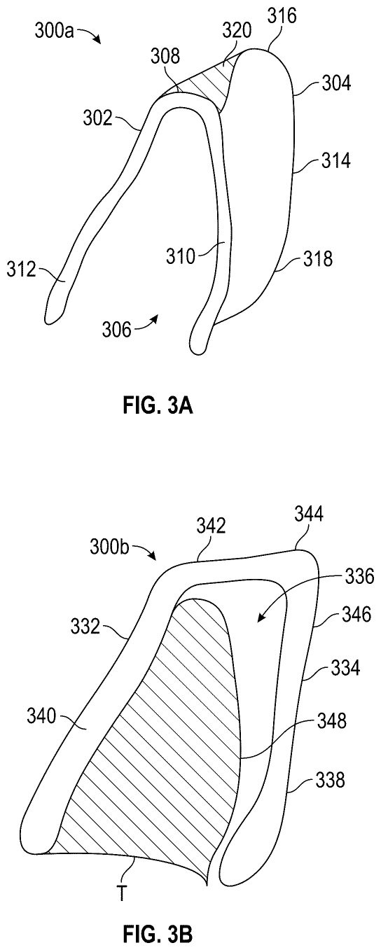

Referring now to FIG. 2B, the mask region 204 can be connected to the shell 202 to partially or fully cover one or more portions of the shell 202, such as the occlusal wall, buccal wall, and/or lingual wall. For instance, as depicted in FIG. 2B, the tooth mask 214 of the mask region 204 partially or fully covers the buccal wall 210 and occlusal wall 208 of the cavity 206 that receives the tooth to be covered by the tooth mask 214. In other embodiments, however, the tooth mask 214 can be configured differently, e.g., the tooth mask 214 may additionally cover the lingual wall 212; may cover the occlusal wall 208 only, the buccal wall 210 only, or the lingual wall 212 only; etc. As shown in FIG. 2B, the mask region 204 can be solid, such that the entire volume between the external surface of the mask region 204 and the externally oriented surfaces of the shell 202 is filled with a continuous solid material. In other embodiments, however, the mask region 204 may be hollow, e.g., as described below in connection with FIG. 3B.

The mask region 204 can have a variety of suitable geometries. For instance, the mask region 204 (e.g., tooth mask 214) can include an occlusal portion 218 and a gingival portion 220. The occlusal portion 218 can be at or proximate to the occlusal surface of the underlying tooth, and the gingival portion 220 can be at or proximate to the gingival margin of the underlying tooth. In some embodiments, the gingival portion 220 of the mask region 204 terminates at or before the gingival margin, such that the mask region 204 covers only the tooth and not the gingiva. Alternatively, the gingival portion 220 of the mask region 204 can extend past the gingival margin, such that the mask region 204 also covers part of the gingiva (e.g., gingival portion 221 in FIG. 2C). The occlusal portion 218 can contact one or more of the occlusal wall 208, buccal wall 210, and/or lingual wall 212 of the shell 202. In some embodiments, the occlusal portion 218 projects outwardly from the shell 202 in one or more of the occlusal and/or buccal directions. For instance, the occlusal portion 218 can extend vertically above (e.g., be taller than) the occlusal wall 208 of the shell 202, e.g., by a height H1. The height H1 can be in the range of 0.1 mm to 20 mm, such as 0.1 mm to 1 mm, 0.5 mm to 1 mm, 0.5 mm to 2 mm, 1 mm to 2 mm, 1 mm to 3 mm, 1 mm to 5 mm, 1 mm to 20 mm, 2 mm to 5 mm, 2 mm to 20 mm, 5 mm to 10 mm, 10 mm to 20 mm, etc. This configuration can provide various benefits, such as hiding the occlusal wall 208 of the shell 202 to avoid a “shark teeth” effect where the patient appears to have multiple rows of teeth. In other embodiments, however, the occlusal portion 218 of the mask region 204 can be the same height as the occlusal wall 208 of the shell 202, or the occlusal portion 218 of the mask region 204 can be shorter than the occlusal wall 208 of the shell 202.

In the illustrated embodiment, the mask region 204 (e.g., tooth mask 214) extends along the buccal wall 210 of the shell 202 so that the gingival portion 220 of the mask region terminates at or near the gingival edge 222 of the buccal wall 210 of the shell 202. In some embodiments the mask region 204 can have a decreasing thickness from the occlusal portion 218 to the gingival portion 220, e.g., the gingival portion 220 has a first thickness W₁ that is smaller than a second thickness W₂ of the occlusal portion 218, such as by an amount within a range from 0.05 mm to 1 mm, 0.05 mm to 1.5 mm, 1 mm to 2 mm, 2 mm to 5 mm, or 0.05 mm to 5 mm. In some embodiments, this configuration provides improved patient comfort and/or an improved aesthetic appearance by creating a more subtle transition from the gingival edge of the dental appliance 200 to the patient's gingiva. Alternatively, the mask region 204 can have an increasing thickness from the occlusal portion 218 to the gingival portion 220 (e.g., the first thickness W₁ can be greater than the second thickness W₂), or the mask region 204 can have a uniform thickness from the occlusal portion 218 to the gingival portion 220 (e.g., such that the first thickness W₁ is equal to the second thickness W₂).

Referring now to both FIGS. 2C and 2D, the mask region 204 can include a mesial portion 224 and distal portions 226. The mesial portion 224 can be thicker than the distal portions 226, e.g., tooth masks 214b-e can be thicker than tooth masks 214a, 214f. In some embodiments, this configuration provides improved patient comfort and/or an improved aesthetic appearance by creating a more subtle transition from the mask region 204 to the portions of the shell 202 that are not covered by the mask region 204. In other embodiments, however, the mesial portion 224 can be the same thickness as the distal portions 226, or the mesial portion 224 can be thinner than the distal portions 226.

Referring next to FIG. 2E, a patient may wear a set of one or more dental appliances 200, such as a first dental appliance 200 on the lower teeth and a second dental appliance 200 on the upper teeth. The mask region 204 of each dental appliance 200 can be partially or fully opaque, such that when the dental appliance 200 is worn, the teeth underlying the mask region 204 are obscured and thus the tooth masks 214 of the mask region 204 appear to be the patient's actual teeth. The mask region 204 can also include one or more aesthetic features that mimic the natural appearance of teeth. For example, the mask region 204 can be colored to resemble the patient's actual teeth and/or idealized teeth, e.g., with a white or yellow hue. As a result, the mask regions 204 can both resemble a dentition with corrected teeth and hide discoloration while concealing the patient's current teeth. Alternatively, the one or more aesthetic features can include other colors (e.g., red, blue, green) and/or integrated components (e.g., sparkles, designs) that may not necessarily resemble the natural appearance of teeth but are desired by the patient.

The aesthetic features described with reference to the mask region 204 can alternatively or additionally be included in other portions of the dental appliance 200, such as the shell 202. For instance, the shell 202 can include coloring (e.g., to resemble the patient's natural teeth and/or idealized teeth or other desired colors), integrated components (e.g., sparkles, designs), etc. In other embodiments, however, the shell 202 may not include additional aesthetic features, e.g., the shell 202 may be transparent and/or non-colored.

As will be discussed further in Section I.B. below, the dental appliance 200 (e.g., the mask region 204 and/or the shell 202) can be formed from one or more materials that provide the desired aesthetic features presented herein. For example, the dental appliance 200 can be fabricated from a composition including a polymeric material (e.g., a polymeric resin) and one or more additives, such as fillers, coloring agents, etc. In some embodiments, the material used to fabricate the dental appliance 200 may be softer and/or less stiff than conventional materials used for dental appliances, since the presence of the mask region 204 can increase the thickness of the dental appliance compared to conventional dental appliances. For instance, the storage modulus of the material can be within a range from 100 MPa to 1000 MPa, or from 200 MPa to 800 MPa, e.g., as measured using dynamic mechanical analysis at room temperature (e.g., 20-25° C.) and/or at physiological temperature (e.g., 37° C.). In some embodiments, the material is a biosafe, biodegradable, and/or recyclable polymer, such as polycaprolactone. Additional examples and details of materials that may be used for the dental appliance 200 are provided in Section I.B. below.

In some embodiments, the mask region 204 provides other benefits in addition to aesthetic features. For instance, the increased thickness due to the presence of the mask region 204 can facilitate or improve certain types of tooth movements, and/or may increase the accuracy of forces applied to the teeth for moving teeth to a target position and/or retaining teeth in a target position.

Although FIGS. 2A-2E are described in connection with “active” dental appliances that apply repositioning forces to a patient's teeth, the present technology is also applicable to “passive” dental appliances that do not apply repositioning forces to the patient's teeth, such as retainers, mouth guards, etc. In such embodiments, the shell and mask region of a passive dental appliance can include any of the features described above in connection with FIGS. 2A-2E, except that the shell is configured to receive the patient's teeth without applying repositioning forces to the teeth. In some embodiments, a passive dental appliance may be used to “preview” the outcome of a treatment plan, e.g., the dental appliance can include a shell that fits a patient's initial (e.g., pre-treatment) tooth arrangement and a mask region that mimics the target tooth arrangement to be achieved through the treatment plan. Accordingly, the dental appliance can be worn by the patient to allow the patient and/or clinician to evaluate the treatment outcome, provide feedback on any desired changes, etc. Alternatively or in combination, a passive dental appliance may be provided to the patient as a removable cosmetic accessory for temporarily disguising aesthetically undesirable teeth without requiring treatment (e.g., for special occasions).

FIGS. 3A-6B illustrate additional features that may be incorporated into the dental appliances of the present technology. For example, any of the features of the embodiments of FIGS. 3A-6B can be incorporated into the dental appliance 200 of FIGS. 2A-2E. Moreover, any of the features of the embodiments of FIGS. 3A-6B can be combined with each other.

FIGS. 3A and 3B are cross-sectional views of dental appliances with mask regions, in accordance with embodiments of the present technology. Referring first to FIG. 3A, a dental appliance 300a can include a shell 302 and a mask region 304 connected to the shell 302. The shell 302 can be generally similar to the shell 202 of the dental appliance 200 of FIGS. 2A-2E. For instance, the shell 302 can include a plurality of cavities configured to receive some or all of a patient's teeth and optionally, apply one or more repositioning forces on the received teeth. For example, as shown in FIG. 3A, the shell 302 includes a cavity 306 that is adjacent to and defined by occlusal wall 308, buccal wall 310, and lingual wall 312 of the shell 302.

The mask region 304 can be generally similar to the mask region 204 of the dental appliance 200 of FIGS. 2A-2E. For instance, the mask region 304 can be connected to (e.g., integrally formed with) the shell 302 to provide an aesthetic benefit when the dental appliance 300a is worn by the patient. In some embodiments, as depicted, the mask region 304 contacts and/or covers the occlusal wall 308 and the buccal wall 310 of the shell 302. The mask region 304 can include a tooth mask 314. The tooth mask 314 can be generally similar to the tooth masks 214 of the dental appliance 200 of FIGS. 2A-2E. For instance, the tooth mask 314 can cover a tooth of the patient, e.g., an anterior tooth of the patient. The tooth mask 314 can include an occlusal portion 316 and a gingival portion 318. In some embodiments, the occlusal portion 316 extends vertically above (e.g., is taller than) the occlusal wall 308 of the shell 302.

In some embodiments, the dental appliance 300a includes a transition region 320 connecting the occlusal portion 316 of the tooth mask 314 to the occlusal wall 308 of the shell 302. The transition region 320 can be configured to provide a smooth, gradual transition between the tooth mask 314 and the shell 320. For instance, the transition region 320 can be a smoothed ramp region that fills in any sharp edges, gaps, recesses, discontinuities, etc., between the tooth mask 314 and the shell 302 to create the appearance of a single continuous tooth. The transition region 320 may be solid (e.g., as shown in FIG. 3A) or may be hollow. The presence of the transition region 320 can advantageously avoid the “shark teeth” effect when the dental appliance 300a is worn by the patient. The transition region 320 may be aesthetically beneficial, for example, in situations where the current position of the tooth differs significantly from the target position of the tooth, such that there is a significant vertical and/or lateral offset between the tooth mask 314 and the shell 320.

Turning now to FIG. 3B, a dental appliance 300b can include a shell 332 and a mask region 334 connected to the shell 332. The shell 332 can be generally similar to the shell 202 of the dental appliance 200 of FIGS. 2A-2E. For instance, the shell 332 can include a plurality of cavities configured to receive some or all of a patient's teeth and optionally, apply one or more repositioning forces on the received teeth. For example, as shown in FIG. 3B, the shell 332 includes a cavity 336 configured to receive a tooth T (e.g., an anterior tooth of the patient).

The mask region 334 can be connected to (e.g., integrally formed with) the shell 332 to provide an aesthetic benefit when the dental appliance 300b is worn by the patient. For example, the mask region 334 can include a tooth mask 338 that is configured to cover the tooth T. In the illustrated embodiment, the mask region 334 is hollow, such that the interior surface of the mask region 334 is directly adjacent to the cavity 336 of the shell 332. As shown in FIG. 3B, the shell 332 can include a lingual wall 340 and an occlusal wall 342, and the mask region 334 can include an occlusal portion 344 and a buccal portion 346 that collectively serve as the tooth mask 338. The occlusal wall 342 of the shell 332 can be connected to the occlusal portion 344 of the mask region 334. Accordingly, the cavity 336 can be defined by the lingual wall 340 and occlusal wall 342 of the shell 332, and by the occlusal portion 344 and buccal portion 346 of the mask region 334. The cavity 336 can be larger than the tooth T such that there is a gap between the interior surface of the mask region 334 and a corresponding surface 348 of the tooth T (e.g., the buccal surface of the tooth T). The gap can accommodate movement of the tooth T toward a target position, e.g., according to the target tooth arrangement represented by the mask region 334.

Conventional dental appliances generally include interproximal portions that are smoothed and/or shallower compared to the natural interproximal regions of the teeth. Thus, if the appliance is fabricated from an opaque material that hides the natural interproximal regions of the teeth, the interproximal portions of the appliance may have diminished shadowing and/or visibility than the natural interproximal regions. This may cause the “teeth” of the dental appliance to look more fake due to blending of neighboring teeth, thus making it more apparent that the patient is wearing a dental appliance over their natural teeth. Accordingly, to address these and other challenges, the dental appliances described herein can include interproximal portions that are enhanced or otherwise modified to provide a more realistic, natural appearance.

FIGS. 4A-4C illustrate dental appliances with enhanced interproximal portions, in accordance with embodiments of the present technology. For example, FIG. 4A is a front view of a dental appliance 400a with colored interproximal portions, in accordance with embodiments of present technology. The dental appliance 400a includes a shell 402 and a mask region 404 connected to the shell 402. The shell 402 can be generally similar to the shell 202 of the dental appliance 200 of FIGS. 2A-2E. For instance, the shell 402 can include a plurality of cavities configured to receive some or all of a patient's teeth and optionally, apply one or more repositioning forces on the received teeth. The mask region 404 can be generally similar to the mask region 204 of the dental appliance 200 of FIGS. 2A-2E. For instance, the mask region 404 can be connected to (e.g., integrally formed with) the shell 402 to provide an aesthetic benefit when the dental appliance 400a is worn by the patient. The mask region 404 can include one or more tooth masks 406 that each cover a respective tooth of the patient, e.g., similar to the tooth masks 214 of the dental appliance 200 of FIGS. 2A-2E.

In some embodiments, the mask region 404 includes one or more interproximal portions 408 between neighboring tooth masks 406. The interproximal portions 408 can correspond to the interproximal regions of the patient's teeth, e.g., the interproximal portions 408 can be configured to resemble the appearance of the natural interproximal regions of the underlying teeth. In the illustrated embodiment, the interproximal portions 408 are colored to mimic the natural shadowing of the interproximal regions of the teeth. For example, the interproximal portions 408 can have a different color and/or be darker than the remaining portions of the tooth masks 406. Optionally, the interproximal portions 408 can include variable shading, as depicted in FIG. 4A. In some embodiments, the interproximal portions 408 include a gradient of shading, such as increasing darkness along an occlusal-gingival direction, or vice-versa. The coloring of the interproximal portions 408 can be provided through the use of one or more coloring agents, as will be described with connection to Section I.B.

FIGS. 4B and 4C are front and top views, respectively, of a dental appliance 400b including deepened interproximal portions, in accordance with embodiments of the present technology. The dental appliance 400b includes a shell 422 and a mask region 424 connected to the shell 422. The shell 422 can be generally similar to the shell 202 of the dental appliance 200 of FIGS. 2A-2E. For instance, the shell 422 can include a plurality of cavities configured to receive some or all of a patient's teeth and optionally, apply one or more repositioning forces on the received teeth. The mask region 424 can be generally similar to the mask region 204 of the dental appliance 200 of FIGS. 2A-2E. For instance, the mask region 424 can be connected to (e.g., integrally formed with) the shell 422 to provide an aesthetic benefit when the dental appliance 400b is worn by the patient. The mask region 424 can include one or more tooth masks 426 that each cover a respective tooth of the patient, e.g., similar to the tooth masks 214 of the dental appliance 200 of FIGS. 2A-2E.

In some embodiments, the mask region 424 includes one or more interproximal portions 428 between neighboring tooth masks 426. The interproximal portions 428 can correspond to the interproximal regions of the patient's teeth, e.g., the interproximal portions 428 can be configured to resemble the appearance of the natural interproximal regions of the underlying teeth. In the illustrated embodiment, the interproximal portions 428 are deepened to create a shadowing effect that mimics the natural shadows at the interproximal regions of the teeth. A s best seen in FIG. 4C, each interproximal portion 428 can include a groove 430 (e.g., a channel, crevice, indentation) formed in a buccal surface of the dental appliance 400b and extending in a lingual direction. The groove 430 can have a depth within a range from 50 μm to 5 mm, such as from 50 μm to 500 μm, 500 μm to 1 mm, 1 mm to 3 mm, 3 mm to 5 mm, etc. The groove 430 can have uniform depth or can have a variable depth, e.g., the groove 430 may be deeper near the occlusal portions of the teeth and shallower near the gingiva, or vice-versa.

The features of the dental appliance 400a of FIG. 4A may be combined with the features of the dental appliance 400b of FIGS. 4B and 4C, e.g., a single dental appliance may include interproximal portions that are colored and include deepened grooves to create a more natural appearance.

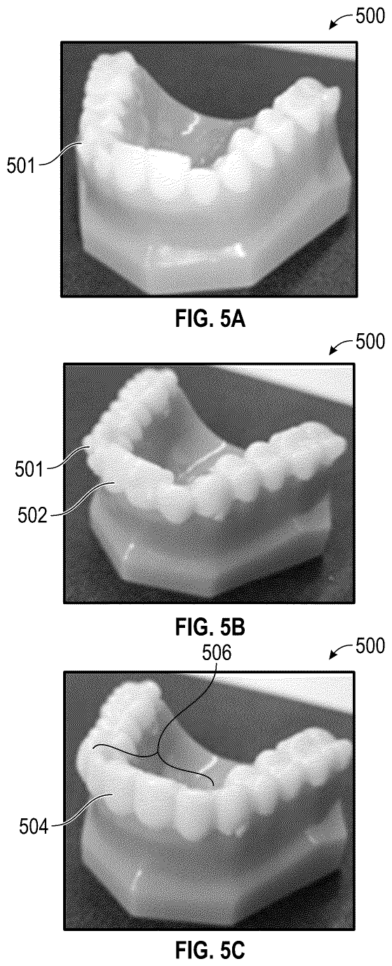

FIGS. 5A-5C illustrate improved aesthetics that may be achieved with a dental appliance having enhanced interproximal portions, in accordance with embodiments of the present technology. Specifically, FIG. 5A is a perspective view of a dental model 500 of a patient's teeth, FIG. 5B is a perspective view of a nontransparent dental appliance 502 without a mask region on the dental model 500, and FIG. 5C is a perspective view of a nontransparent dental appliance 504 with a mask region 506 on the dental model 500.

Referring first to FIG. 5A, the dental model 500 represents the patient's teeth in a current, maloccluded arrangement. Additionally, some of the teeth include attachments 501. Referring next to FIG. 5B, the dental appliance 502 does not include a mask region and thus still presents the appearance of the underlying maloccluded teeth and attachments 501 when worn. The interproximal portions of the dental appliance 502 are shallower than the actual interproximal regions of the teeth and are therefore less visible and/or less shadowed compared to the dental model 500. Accordingly, the dental appliance 502 may provide a less realistic depiction of the patient's teeth when worn.

Referring now to FIG. 5C, the dental appliance 504 includes a mask region 506 that represents the patient's teeth in a target, non-maloccluded arrangement. Moreover, the interproximal portions of the mask region 506 have been deepened to provide a shadowing effect when worn. As shown in FIG. 5C, the dental appliance 504 covers the maloccluded teeth and attachments, providing a realistic depiction of the teeth in the target arrangement.

In some situations, a dental appliance may be used in combination with a second device mounted on the patient's teeth, such as an attachment, button, bracket, hook, wire, sensor, etc. The dental appliance can engage the second device to produce a desired force on one or more teeth, e.g., a repositioning force. Alternatively or in combination, the second device may serve other functions, such as facilitating retention of the dental appliance on the teeth, engaging elastics or other components that are used in combination with the dental appliance to effectuate tooth repositioning, providing sensing capabilities (e.g., compliance monitoring), etc. The presence of the second device on the patient's teeth may be aesthetically undesirable, e.g., if the second device is attached to an anterior tooth or is otherwise readily visible. Moreover, the presence of the second device may produce discomfort, e.g., if the second device is in contact with the patient's lips, cheeks, or tongue; if the second device has sharp features, etc. Accordingly, to address these and other challenges, the dental appliances described herein can include a mask region that covers the second device to reduce visibility and/or improve patient comfort.

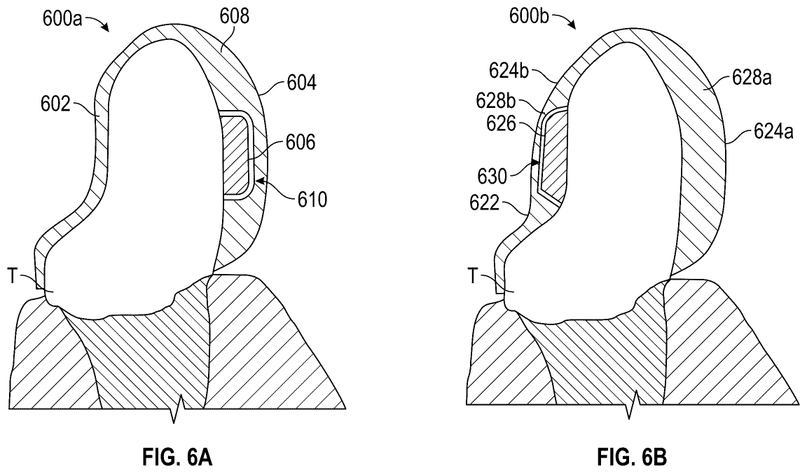

FIGS. 6A and 6B illustrate dental appliances for covering a tooth-mounted attachment, in accordance with embodiments of the present technology. For example, FIG. 6A is a cross-sectional view of a dental appliance 600a including a shell 602 and a mask region 604 for covering a buccal attachment 606. The shell 602 can be generally similar to the shell 202 of the dental appliance 200 of FIGS. 2A-2E, and the mask region 604 can be generally similar to the mask region 204 of the dental appliance 200 of FIGS. 2A-2E. For instance, the shell 602 can include a plurality of cavities configured to receive some or all of a patient's teeth and optionally, apply one or more repositioning forces on the received teeth. The mask region 604 can be connected to (e.g., integrally formed with) a buccal wall of the shell 602 to provide an aesthetic benefit when the dental appliance 600a is worn by the patient. In some embodiments, the mask region 604 includes a tooth mask 608 that covers a tooth T of the patient. The tooth mask 608 can be configured to depict the tooth T in a target tooth arrangement, such as a non-maloccluded tooth arrangement.

In the illustrated embodiment, an attachment 606 is mounted on the buccal surface of the tooth T. The attachment 606 can engage the dental appliance 600a to apply repositioning forces on the tooth T, for example. As shown in FIG. 6A, the dental appliance 600a (e.g., the shell 602 and/or mask region 604) can include a receptacle 610 formed therein to receive and engage the attachment 606. For instance, the recess 610 can be a recess, indentation, relief, etc., having a geometry corresponding to the exterior geometry of the attachment 606. The tooth mask 608 of the mask region 604 can extend over the receptacle 610, thus covering the attachment 606 when the dental appliance 600a is worn on the tooth T.

FIG. 6B is a cross-sectional view of a dental appliance 600b including a shell 622, a first mask region 624a, and a second mask region 624b for covering a lingual attachment 626. The shell 622 can be generally similar to the shell 202 of the dental appliance 200 of FIGS. 2A-2E, and the first mask region 624a can be generally similar to the mask region 204 of the dental appliance 200 of FIGS. 2A-2E. For instance, the shell 622 can include a plurality of cavities configured to receive some or all of a patient's teeth and optionally, apply one or more repositioning forces on the received teeth. The first mask region 624a can be connected to (e.g., integrally formed with) a buccal wall of the shell 622 to provide an aesthetic benefit when the dental appliance 600b is worn by the patient. In some embodiments, the first mask region 624a includes a first tooth mask 628a that covers a tooth T of the patient. The first tooth mask 628a can be configured to depict the tooth T in a target tooth arrangement, such as a non-maloccluded tooth arrangement. In other embodiments, however, the first mask region 624a is optional and may be omitted.

In the illustrated embodiment, an attachment 626 is mounted on the lingual surface of the tooth T. The attachment 626 can engage the dental appliance 600b to apply repositioning forces on the tooth T, for example. As shown in FIG. 6B, the dental appliance 600b can include a second mask region 624b that is connected to (e.g., integrally formed with) a lingual wall of the shell 622. The shell 622 and/or second mask region 624b can include a receptacle 630 formed therein to receive and engage the attachment 626. For instance, the recess 630 can be a recess, indentation, relief, etc., having a geometry corresponding to the exterior geometry of the attachment 606. The second mask region 624b can include a second tooth mask 628b that extends over the receptacle 630, thus covering the attachment 626 when the dental appliance 600b is worn on the tooth T. In some embodiments, the second tooth mask 628b has a smooth external surface, e.g., to hide the presence of the attachment 626 and/or to reduce patient discomfort due to the attachment 626.

The dental appliances 600a, 600b illustrated in FIGS. 6A and 6B can provide various benefits. For example, the dental appliances 600a, 600b can allow for larger and/or more geometrically complex attachments than would otherwise possible due to aesthetic and/or comfort issues, such as attachments with protruding and/or sharp features. Moreover, the dental appliances 600a, 600b may be used to cover other types of tooth-mounted devices besides attachments, such as buttons, hooks, brackets, wires, sensors, etc. In some embodiments, tooth-mounted devices such as attachments, buttons, hooks, brackets, wires, sensors, etc., may be only partially hidden by the mask region, e.g., if adding more thickness is undesirable or the device needs to be partially exposed to function properly. In such embodiments, the tooth-mounted device may be uncovered or only partially covered, and may protrude through the surface of the dental appliance (e.g., via an aperture or recess formed in the surface of the mask region).

A mask region of a dental appliance may be configured to hide a feature of the dental appliance itself, alternatively or in addition to covering a patient's tooth and/or a tooth-mounted device. For instance, a shell of a dental appliance may include force application features formed therein, such as ridges, dimples, pressure points, etc. Conventionally, a force application feature such as a ridge or dimple is formed in the shell simply by indenting a portion of shell, thus producing a corresponding ridge or dimple in the external surface of the shell. To provide an improved aesthetic appearance, the dental appliances described herein can include a mask region positioned over the external ridge or dimple to provide a smooth external surface.

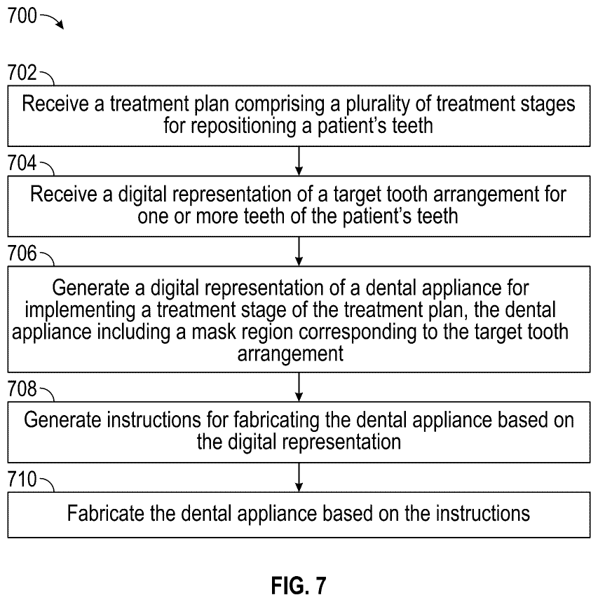

FIG. 7 is a flow diagram illustrating a method 700 for designing and fabricating a dental appliance, in accordance with embodiments of the present technology. The method 700 can be performed to design and fabricate any of the devices described herein, such as any of the embodiments of FIGS. 2A-6B. In some embodiments, some or all of the processes of the method 700 are implemented as computer-readable instructions (e.g., program code) that are configured to be executed by one or more processors of a computing device, such as a controller of a digital design system or manufacturing system.

The method 700 can begin at block 702 with receiving a treatment plan comprising a plurality of treatment stages for repositioning a patient's teeth. In some embodiments, the treatment plan includes repositioning one or more teeth from a first (e.g., initial) tooth arrangement toward a second (e.g., target or final) tooth arrangement via a plurality of intermediate tooth arrangements, with each intermediate tooth arrangement corresponding to a respective treatment stage of the treatment plan. The treatment plan can be implemented by successively applying a series of dental appliances (e.g., aligners) to the patient's teeth, with each dental appliance configured to reposition the teeth toward a respective intermediate tooth arrangement specified by the corresponding treatment stage. For example, each dental appliance can include a shell corresponding to the respective intermediate tooth arrangement, e.g., the cavities of the shell are configured to reposition one or more teeth toward the positions specified by the intermediate tooth arrangement. The treatment plan can be received as a set of digital representations depicting the patient's teeth in the first tooth arrangement, intermediate tooth arrangements, and second tooth arrangement. The digital representations can be 3D models, 2D images, and/or any other digital data set suitable for depicting the positions and geometries of the teeth in the tooth arrangements.

The method 700 can continue at block 704 with receiving a digital representation of a target tooth arrangement for one or more teeth of the patient's teeth. The target tooth arrangement can represent a tooth arrangement that is aesthetically desirable, such an arrangement without maloccluded teeth, damaged teeth, missing teeth, visible tooth-mounted hardware, etc. In some embodiments, the target tooth arrangement is the second tooth arrangement to be achieved by the treatment plan, while in other embodiments, the target tooth arrangement may be a different tooth arrangement from the treatment plan (e.g., an intermediate tooth arrangement) or may be a tooth arrangement that is not part of the treatment plan.

The digital representation can include one or more 3D models, 2D images, and/or other digital data sets suitable for depicting the positions and geometries of one or more teeth according to the target tooth arrangement. For instance, the digital representation can show each tooth in a target position (e.g., a non-maloccluded position) and/or with a target geometry (e.g., a non-damaged shape). In some embodiments, the digital representation depicts all of the patient's teeth in the target tooth arrangement, while in other embodiments, the digital representation may depict only a subset of the patient's teeth in the target tooth arrangement, such as the anterior teeth only.

The digital representation can be received as part of the treatment plan (e.g., in embodiments where the target tooth arrangement is one of the tooth arrangements of the treatment plan). Alternatively, the digital representation can be received separately (e.g., in embodiments where the target tooth arrangement is not one of the tooth arrangements of the treatment plan). In such embodiments, the digital representation of the target tooth arrangement may be generated by a clinician (e.g., based on intraoral scan data or other data of the patient's teeth), may be received from a datastore of generic tooth arrangements (e.g., a library of generic, ideal, or artificial tooth arrangements), or suitable combinations thereof.

The method 700 can continue at block 706 with generating a digital representation of a dental appliance for implementing a treatment stage of the treatment plan, the dental appliance including a mask region corresponding to the target tooth arrangement. The dental appliance can include any of the embodiments described herein, e.g., in connection with FIGS. 2A-6B. For example, the dental appliance can include a shell including a plurality of cavities configured to receive the patient's teeth and, optionally, reposition the patient's teeth according to the intermediate tooth arrangement of the treatment stage. The mask region can be connected to (e.g., integrally formed with) the shell to cover at least one tooth and to depict the tooth according to the target tooth arrangement. In some embodiments, the mask region includes a tooth mask that covers one or more surfaces of a corresponding tooth (e.g., the buccal, occlusal, and/or lingual surfaces) and depicts the tooth in the target position and/or with the target geometry specified by the target tooth arrangement.

The digital representation of the dental appliance can include one or more 3D models, 2D images, and/or other digital data sets suitable for depicting the geometry (e.g., shape, size, features) of the dental appliance. Optionally, the digital representation can include color information for the dental appliance (e.g., RGB values, HSB values). As described herein, a portion of the dental appliance (e.g., the mask region and/or the shell) or the entire dental appliance may be colored, e.g., to mimic the natural color of the patient's intraoral tissues such as the teeth, gingiva, palate, etc., or according to another desired color. In some embodiments, the method further includes receiving color information of the patient's teeth (e.g., from intraoral scan data and/or photographs of the patient's teeth) and selecting one or more colors for at least a portion of the dental appliance, based on the received color information. For instance, the coloring of the mask region and/or shell can be selected to match the color of the patient's teeth.

The digital representation of the dental appliance can be generated using many different techniques. In some embodiments, for example, the process of block 706 includes receiving a first digital representation of the shell, receiving a second digital representation of the mask region, and combining the first digital representation and the second digital representation to produce the digital representation of the dental appliance. The first digital representation of the shell can be based on the intermediate tooth arrangement of the treatment plan received in block 702. For instance, the first digital representation can be a 3D digital model of the shell of the dental appliance, with the geometry of the shell being configured to receive and reposition the teeth toward the intermediate tooth arrangement. The first digital representation may be generated based on the intermediate tooth arrangement using suitable appliance design software algorithms, such as rule-based algorithms, machine learning algorithms, etc.

The second digital representation of the mask region can be based on the target tooth arrangement received in block 704. For instance, the second digital representation can be a 3D digital model of the mask region including one or more tooth masks that are positioned and shaped according to the positions and geometries of one or more corresponding teeth in the target tooth arrangement. In some embodiments, the second digital representation is generated by identifying at least one tooth in the intermediate tooth arrangement to be covered by the mask region, and extracting a section of the digital representation of the target tooth arrangement corresponding to the at least one tooth.

Optionally, the process of block 704 can include modifying the extracted section to improve the aesthetics of the resulting dental appliance. For example, the modifications can include enhancing the interproximal portions of the extracted section, such as by increasing the depth of the interproximal portions, changing the color of the interproximal portions, or suitable combinations thereof. In embodiments where the dental appliance is to be fabricated using an additive manufacturing technique, the process of block 704 can involve determining the effect of material viscosity on the printing of the interproximal portions, which may limit the depth of the interproximal portions and/or the ability to remove uncured resin from the interproximal portions. The process of block 704 can also include adjusting a smoothing function that is applied to the appliance geometry (e.g., reducing the amount of applied smoothing) to ensure that the interproximal portions remain sufficiently deep when fabricated to achieve the desired aesthetic effect. As another example, the modification can include increasing the height of the extracted section, e.g., by 1 mm to 5 mm, to provide better coverage of the patient's actual teeth and avoid the shark teeth effect.

The first and second digital representations can be combined with each other to generate the digital representation of the dental appliance. In some embodiments, the first and second digital representations are overlaid with each other and then merged into a single digital representation. The combining process can include removing portions of the first and/or second digital representations that conflict with each other. For instance, portions of the second digital representation that would protrude into the cavities of the shell or otherwise interfere with the function of the shell may be removed. The combining process can optionally include creating a smooth transition between the first digital representation and the second digital representation. For example, the gingival portions and/or distal portions of the second digital representation can be thinned to provide a more natural transition between the mask region and the underlying shell. As another example, a transition region such as a ramp can be added to provide a smooth, continuous occlusal surface between the mask region and the shell that avoids the shark teeth effect. In some embodiments, when the first and second digital representations are combined, the result is a mask region that follows the buccal curvature of the patient's underlying teeth and has a 3D thickness gradient with maximum thickness at the crown centers, and tapering toward the outer boundaries of the mask region (e.g., thinner near the gingival and distal portions of the mask region).

The method 700 can continue at block 708 with generating instructions for fabricating the dental appliance based on the digital representation. The instructions can be configured for direct fabrication of the dental appliance (e.g., via additive manufacturing) or for indirect fabrication of the dental appliance (e.g., via thermoforming). In some embodiments, the instructions are or include a digital representation of the appliance design, such as a CAD file, STL file, OBJ file, AMF file, 3MF file, etc. Alternatively or in combination, the instructions can include a toolpath file that is in a format suitable for direct input to the controller of an appliance fabrication systems, such as a G-code file.

The method 700 can continue at block 710 with fabricating the dental appliance based on the instructions. In some embodiments, the dental appliance is fabricated using an additive manufacturing technique, such as any of the additive manufacturing techniques described herein, e.g., in Section III below. For instance, the additive manufacturing technique can include fabricating the dental appliance from a curable material (e.g., a resin) in a layer-by-layer manner. Alternatively, the dental appliance can be fabricated using a thermoforming process in which one or more sheets of material are heated and applied to a mold of the dental appliance. The dental appliance can be fabricated from any suitable material or combination of materials, e.g., as described further in Section I.B below.

The method 700 illustrated in FIG. 7 can be modified in many different ways. For example, the ordering of the processes shown in FIG. 7 can be varied, some of the processes of the method 700 can be omitted, and/or the method 700 can include additional processes not shown in FIG. 7. For instance, the method 700 can include performing one or more post-processing operations on the dental appliance after fabrication, such as removing excess material (e.g., uncured resin) from the appliance, washing the appliance, post-curing the appliance, applying a coating or other surface treatment to the appliance, etc. In some embodiments, the excess material is removed using techniques to reduce the amount of material left within the interproximal portions of the appliance, such as centrifugation, heating, and/or solvents. As another example, the process of block 702 may be omitted, such that the method 700 may be used to design and fabricate dental appliances that do not reposition the patient's teeth, such as any of the passive dental appliances described herein.

Although certain embodiments of the present technology are described in connection with dental appliances having a mask region to cover one or more teeth, a mask region may alternatively or additionally serve other functions. For instance, a mask region can be used to disguise a missing tooth, e.g., by providing a tooth mask that simulates the appearance of a normal tooth. In such embodiments, the mask region may be solid or hollow, and/or may or may not rest on the patient's gumline. As another example, a mask region can be used can be used to cover both the patient's teeth and gingiva, or can be used to cover the gingiva only without covering the patient's teeth (e.g., to mimic the appearance of health gingiva for aesthetic purposes).

### B. Material Compositions for Dental Appliances

In some embodiments, the present technology provides compositions of one or more materials for fabricating dental appliances, such as aligners, palatal expanders, retainers, oral sleep apnea appliances, and mouth guards. For instance, the compositions herein can be used in a dental appliance with a mask region, e.g., as described in Section I.A above. Alternatively, the compositions herein can be used in a dental appliance that does not include a mask region. Other examples of dental appliances that may be fabricated with the compositions described herein are provided in Section II below.

The compositions herein can include one or more materials configured to provide the appropriate properties according to the intended function of the dental appliance, such as aesthetic properties (e.g., opacity, color), mechanical properties (e.g., modulus, elongation to break, elongation to yield, strength, hardness, scratch resistance, stress relaxation), and/or other relevant properties (e.g., glass transition temperature). For instance, in embodiments where the dental appliance is intended to apply repositioning forces to teeth while disguising maloccluded teeth, the dental appliance can be fabricated from a composition having a sufficiently high modulus and strength to generate and maintain forces on the teeth, while also having a desired color and degree of opacity to cover the maloccluded teeth.

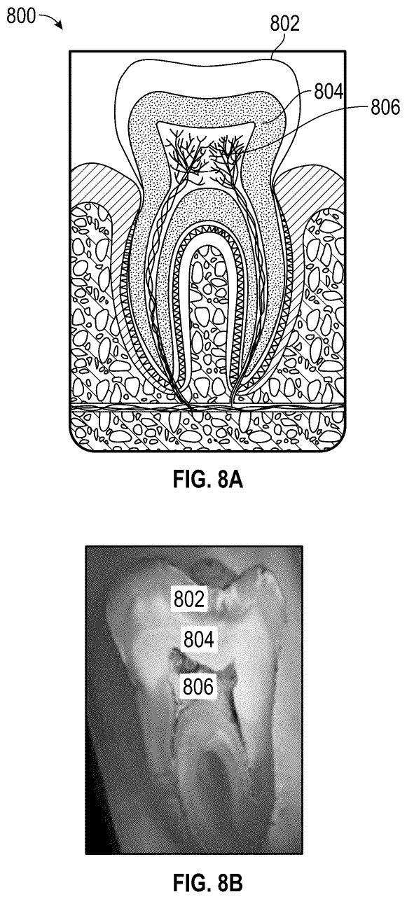

In some embodiments, the compositions of the present disclosure are configured to mimic the natural appearance of a tooth. FIG. 8A is a cross-sectional illustration of a tooth 800, and FIG. 8B is an image of a cross-section of an actual tooth. As shown in FIGS. 8A and 8B, the tooth 800 includes an outer layer of enamel 802 and an inner layer of dentin 804 surrounding the pulp 806 of the tooth 800. Typically, the enamel 802 is partially or highly transparent, while the dentin 804 is very mineralized and opaque. This combination of transparent and opaque layers gives teeth their natural appearance.

In some embodiments, the compositions herein are at least partially opaque (e.g., nontransparent or translucent). The opacity of a material may be characterized by measuring the amount of light transmittance through a sample of the material. In some embodiments, the compositions herein have a transmittance value in a 1 mm thick sample that is less than or equal to 95%, 90%, 85%, 80%, 75%, 70%, 65%, 60%, 55%, 50%, 45%, 40%, 35%, 30%, 25%, 20%, 15%, 10%, 5%, 2%, or 1%; and/or is within a range from 0% to 95%, 0% to 80%, 0% to 50%, or 50% or 80%. For example, compositions used in dental appliances that are intended to blend in with the patient's actual teeth may have a transmittance value within a range from 50% to 80%. As another example, compositions used in dental appliances that are intended to cover the patient's actual teeth can have a transmittance value less than 50%. A desired degree of opacity can be achieved by using a base material that is opaque or semi-opaque (e.g., an opaque or semi-opaque polymeric resin), by adding light scattering fillers into a base material (which may or may not be opaque on its own), by applying an opaque or semi-opaque coating to the base material (e.g., via dip coating, spray coating, powder coating, vapor coating), or suitable combinations thereof.

Opaque or semi-opaque materials may better mimic the semi-opaque appearance of natural teeth, and thus may be beneficial for dental appliances that are intended to blend in with the patient's natural teeth or to simulate the appearance of natural teeth. Moreover, opaque or semi-opaque materials may be used to hide teeth with an undesirable appearance, such as teeth that are maloccluded, damaged, missing, stained, or include hardware mounted thereon. Opaque or semi-opaque materials may also be used to provide other desired aesthetic features, such as colors (e.g., colors that are not intended to mimic natural tooth coloration), designs, patterns, sparkles, glow-in-the-dark effects, etc. In some embodiments, opaque or semi-opaque materials can provide improved visibility for components that are attached to the dental appliance, such as stickers, logos, identification markings, etc.

In other embodiments, however, the compositions herein may be partially or completely transparent, e.g., the transmittance value in a 1 mm thick sample is greater than or equal to 80%, 85%, 90%, 95%, 99%; and/or is within a range from 80% to 100%, 90% to 100%, 80% to 95%, or 90% to 95%. A partially or completely transparent dental appliance may be used, for example, in embodiments where the dental appliance includes fillers and/or coloring agents to provide a desired aesthetic effect such as glitter, sparkles, bubbles, color, etc.

In some embodiments, the composition includes a polymeric material, such as a thermoplastic material, a thermoset material, or a combination thereof. The polymeric material can be a transparent polymeric material, a translucent polymeric material, or an opaque polymeric material. The polymeric material can be a polyester (e.g., an aliphatic polyester, an aromatic polyester), a co-polyester, a polycarbonate, a thermoplastic polyurethane, a polypropylene, a polyethylene, a polypropylene and polyethylene copolymer, an acrylic, a cyclic block copolymer, a polyether, a polythioether, a polyetheretherketone, a polyamide, a polyethylene terephthalate, a polybutylene terephthalate, a polyetherimide, a polyethersulfone, a polytrimethylene terephthalate, a styrenic block copolymer (SBC), a polysulfide, a silicone rubber, an elastomeric alloy, a thermoplastic elastomer (TPE), a thermoplastic vulcanizate (TPV) elastomer, a polyurethane elastomer, a polythiourethane, a block copolymer elastomer, a polyolefin blend elastomer, a thermoplastic co-polyester elastomer, a thermoplastic polyamide elastomer, a polycaprolactone, or combinations (e.g., mixtures, copolymers) thereof.

In some embodiments, the polymeric material is a polymeric resin composed of one more polymerizable components (e.g., monomers, oligomers, and/or reactive polymers). The polymerizable components can be any molecule or compound capable of forming bonds with other polymerizable components, thus resulting in a larger molecule with increased molecular weight. In some embodiments, the bond-forming reaction occurs multiple times, such that the molecular weight of the resultant molecule increases with each successive bond-forming reaction. Examples of bond-forming reactions suitable for use with the techniques described herein include, but are not limited to, free radical polymerization, ionic polymerization (e.g., cationic polymerization, anionic polymerization), condensation polymerization, metathesis polymerization, Diels-Alder reactions, photodimerization, carbene formation, nitrene formation, and suitable combinations thereof.

In some embodiments, the polymerizable components include one or more of the following: an acrylate monomer, a methacrylate monomer, a thiol monomer, a vinyl acetate monomer, a vinyl ether monomer, a vinyl chloride monomer, a vinyl silane monomer, a vinyl siloxane monomer, a styrene monomer, an allyl ether monomer, an acrylonitrile monomer, a butadiene monomer, a norbornene monomer, a maleate monomer, a fumarate monomer, an epoxide monomer, an anhydride monomer, or a hydroxyl monomer. In some embodiments, the polymerizable components include one or more of the following: a free radically polymerizable group, a cationically polymerizable group, or an anionically polymerizable group. In some embodiments, the polymerizable components include one or more reactive functional groups, such as one or more of the following: an acrylate, a methacrylate, an acrylamide, a vinyl group, a vinyl ether, a thiol, an allyl ether, a norbornene, a vinyl acetate, a maleate, a fumarate, a methylenemalonate, a maleimide, an epoxide, a ring-strained cyclic ether, a ring-strained thioether, a cyclic ester, a cyclic carbonate, a cyclic silane, a cyclic siloxane, a hydroxyl, an amine, an isocyanate, a blocked isocyanate, an acid chloride, an activated ester, an oxetane, a Diels-Alder reactive group, a furan, a cyclopentadiene, an anhydride, a group favorable toward photodimerization (e.g., an anthracene, an acenaphthylene, or a coumarin), a group that photodegrades into a reactive species (e.g., Norrish Type 1 and 2 materials, photoacids, photobases), an azide, a derivative thereof, or a combination thereof. Additional examples of polymerizable components that may be used are provided in U.S. Pat. No. 10,495,973 and U.S. Patent Publication Nos. 2021/0147672, 2021/0395420, 2022/0380502, and 2023/0021953, the disclosures of each of which are incorporated by reference herein in their entirety.

In some embodiments, the polymeric material is a semicrystalline or microcrystalline material. Microcrystalline materials have crystalline domains that are oriented in many different directions, and that are mixed in with and surrounded by amorphous domains. Because the crystalline domains have many different orientations, the effect is both high and low scattering regions due to the birefringence of the crystalline domains which present different refractive indices depending on viewing angle (for an individual polymer crystal). Therefore, when the appropriate amount of crystallinity is present, the appearance of the composition can be semi-opaque, similar to a tooth. Examples of semicrystalline and microcrystalline materials suitable for use in the present technology are described in U.S. Patent Publication No. 2021/0147672, the disclosure of which is incorporated by reference herein in its entirety.

In some embodiments, the composition further includes at least one filler. The filler can be an inorganic filler, an organic filler, or a suitable combination thereof. Examples of inorganic fillers include titanium dioxide, mica, zinc oxide, iron oxide, zinc ferrite, zinc sulfide, zirconia, and silica. Examples of organic fillers include polystyrene, polyacrylates, polymethacrylates, polyurethanes, cellulose, lignin, and other organic polymers. The filler can have any suitable form factor, such as particles (e.g., nanoparticles, microparticles), fibers (e.g., nanofibers, microfibers), etc. The filler can be biocompatible, nontoxic, and/or food-safe. A filler can be used to confer desired properties to the composition, such as optical properties (e.g., opacity, refractive index, color) and/or mechanical properties (e.g., modulus, strength, scratch resistance). Optionally, the composition can include at least one filler that provides other aesthetic effects, such as sparkles, glitters, bubbles, luminescent materials (e.g., glow in the dark materials), fluorescent materials (e.g., glow under black light materials), etc.

The filler can be present in the composition at any suitable concentration, such as a concentration within a range from 0.1 wt % to 20 wt %, 0.1 wt % to 10 wt %, 0.1 wt % to 5 wt %, 0.1 wt % to 2 wt %, 0.1 wt % to 1 wt %, 0.1 wt % to 0.5 wt %, 0.5 wt % to 20 wt %, 0.5 wt % to 10 wt %, 0.5 wt % to 5 wt %, 0.5 wt % to 2 wt %, 0.5 wt % to 1 wt %, 1 wt % to 20 wt %, 1 wt % to 10 wt %, 1 wt % to 5 wt %, 1 wt % to 2 wt %, 2 wt % to 20 wt %, 2 wt % to 10 wt %, 2 wt % to 5 wt %, 5 wt % to 20 wt %, 5 wt % to 10 wt %, or 10 wt % to 20 wt %. In some embodiments, concentrations greater than 20 wt % are also contemplated. In some embodiments, the concentration of the filler in the composition is at least 0.05 wt %, 0.1 wt %, 0.25 wt %, 0.5 wt %, 0.75 wt %, 1 wt %, 1.5 wt %, 2 wt %, 3 wt %, 4 wt %, 5 wt %, 6 wt %, 7 wt %, 8 wt %, 9 wt %, or 10 wt %. In some embodiments, the concentration of the filler in the composition is no more than 10 wt %, 9 wt %, 8 wt %, 7 wt %, 6 wt %, 5 wt %, 4 wt %, 3 wt %, 2 wt %, 1.5 wt %, 1 wt %, 0.75 wt %, 0.5 wt %, 0.25 wt %, 0.1 wt %, or 0.05 wt %.

For example, the composition can include at least one light scattering filler to adjust the opacity of the composition. The at least one light scattering filler can include a strong scattering filler having a high refractive index contrast with the polymeric material (e.g., the refractive index of the filler is significantly higher or lower than the refractive index of the polymeric material). Alternatively or in combination, the at least one light scattering filler can include a weak scattering filler having a low refractive contrast with the polymeric material (e.g., the refractive index of the filler is similar to the refractive index of the polymeric material). In some embodiments, a strong scattering filler is used to mimic the appearance of dentin (e.g., higher opacity) and a weak scattering filler is used to mimic the appearance of enamel (e.g., lower opacity). The concentration and/or type of light scattering filler used may vary according to appliance thickness. For instance, strong scattering fillers can be present at a lower concentration in thicker portions of the appliance and at a higher concentration in thinner portions of appliance to achieve a similar degree of semi-opaqueness throughout the entire appliance. Weak scattering fillers can be present at a significantly higher concentration in thinner portions of the appliance (e.g., compared to the concentration of the strong scattering filler) and at a higher concentration in thicker portions of the appliance (e.g., compared to the concentration of the strong scattering filler).

In some embodiments, the composition includes at least one coloring agent. For example, the coloring agent can be a pigment or a dye. Optionally, the coloring agent can be a filler that has a desired color, as discussed above. The coloring agent can be biocompatible, nontoxic, and/or food-safe. Examples of coloring agents that may be used include FD & C Blue No. 1, FD & C Blue No. 2, FD & C Green No. 3, Orange B, Citrus Red. No. 2, FD & C Red No. 3, FD & C Red No. 40, FD & C Yellow No. 5, FD & C Yellow No. 6, annatto extract, anthocyanins, astaxanthin, dehydrated beets (beet powder), ultramarine blue, canthaxanthin, caramel, β-apo-8′-carotenal, β-carotene, cochineal extract, carmine, sodium copper chlorophyllin, toasted partially defatted cooked cottonseed flour, ferrous gluconate, ferrous lactate, grape color extract, grape skin extract (enocianina), haematococcus algae meal, synthetic iron oxide, fruit juice, vegetable juice, dried algae meal, tagetes (Aztec marigold) meal and extract, carrot oil, corn endosperm oil, paprika and paprika oleoresin, phaffia yeast, riboflavcin, saffron, sodium copper chlorophyllin, titanium dioxide, turmeric and turmeric oleoresin, mica and mica-based pearlescent pigments, luminescent zinc sulfide, tomato lycopene extract, and carbon black.

The coloring agent may be mixed with the polymeric material or may be covalently coupled to the polymeric material. The coloring agent can be used to provide the dental appliance with a desired color, including natural tooth colors or non-natural tooth colors. The patient can have the option to pick the color of the dental appliance, or the color of the dental appliance can be matched the color of the patient's teeth (e.g., based on intraoral scans, photographs, and/or other data of the patient's teeth that provide color information). Optionally, in embodiments where the coloring agent is used to depict whitened teeth, the color of each dental appliance in the series can be gradually changed from the current color of the patient's teeth to the whitened color to avoid sudden alterations in the appearance of the teeth. The patient may concurrently use whitening products while wearing the dental appliances so that the final result matches the whitened appliance color.

The coloring agent can be present in the composition at any suitable concentration, such as a concentration within a range from 0.1 wt % to 20 wt %, 0.1 wt % to 10 wt %, 0.1 wt % to 5 wt %, 0.1 wt % to 2 wt %, 0.1 wt % to 1 wt %, 0.1 wt % to 0.5 wt %, 0.5 wt % to 20 wt %, 0.5 wt % to 10 wt %, 0.5 wt % to 5 wt %, 0.5 wt % to 2 wt %, 0.5 wt % to 1 wt %, 1 wt % to 20 wt %, 1 wt % to 10 wt %, 1 wt % to 5 wt %, 1 wt % to 2 wt %, 2 wt % to 20 wt %, 2 wt % to 10 wt %, 2 wt % to 5 wt %, 5 wt % to 20 wt %, 5 wt % to 10 wt %, or 10 wt % to 20 wt %. In some embodiments, concentrations greater than 20 wt % are also contemplated. In some embodiments, the concentration of the coloring agent in the composition is at least 0.05 wt %, 0.1 wt %, 0.25 wt %, 0.5 wt %, 0.75 wt %, 1 wt %, 1.5 wt %, 2 wt %, 3 wt %, 4 wt %, 5 wt %, 6 wt %, 7 wt %, 8 wt %, 9 wt %, or 10 wt %. In some embodiments, the concentration of the coloring agent in the composition is no more than 10 wt %, 9 wt %, 8 wt %, 7 wt %, 6 wt %, 5 wt %, 4 wt %, 3 wt %, 2 wt %, 1.5 wt %, 1 wt %, 0.75 wt %, 0.5 wt %, 0.25 wt %, 0.1 wt %, or 0.05 wt %.

In some embodiments, the entire dental appliance is formed from a single composition (e.g., a polymeric material including at least one filler and/or at least one coloring agent) and thus is composed of the same material(s) throughout. For example, in embodiments where the dental appliance includes a shell and a mask region, the shell and mask region can both be formed from the same composition. Alternatively, the dental appliance can be formed from two or more different compositions, such that different portions of the appliance can be composed of different materials. For example, in embodiments where the dental appliance includes a shell and a mask region, the shell can be formed from a first composition and the mask region can be formed from a second, different composition. The first composition can have mechanical properties configured for applying forces to teeth, while the second composition can have optical properties configured for producing a desired aesthetic effect. As another example, portions of the dental appliance that are intended to cover the patient's teeth can be formed from a first composition having a first color that mimics the color of natural teeth, and portions of the dental appliance that are intended to cover other intraoral tissue (e.g., the gingiva and/or palate) can be formed from a second composition having a second color that mimics the color of the intraoral tissue. In a further example, a dental appliance can have a plurality of different portions that are formed from a plurality of different colored compositions to create graphics such as patterns, designs, images, logos, identification markings, etc. Dental appliances formed from a plurality of different compositions can be produced using multi-material manufacturing techniques such as multi-material inkjetting, hybrid additive manufacturing techniques that combine two or more different types of additive manufacturing processes into a single system, etc.

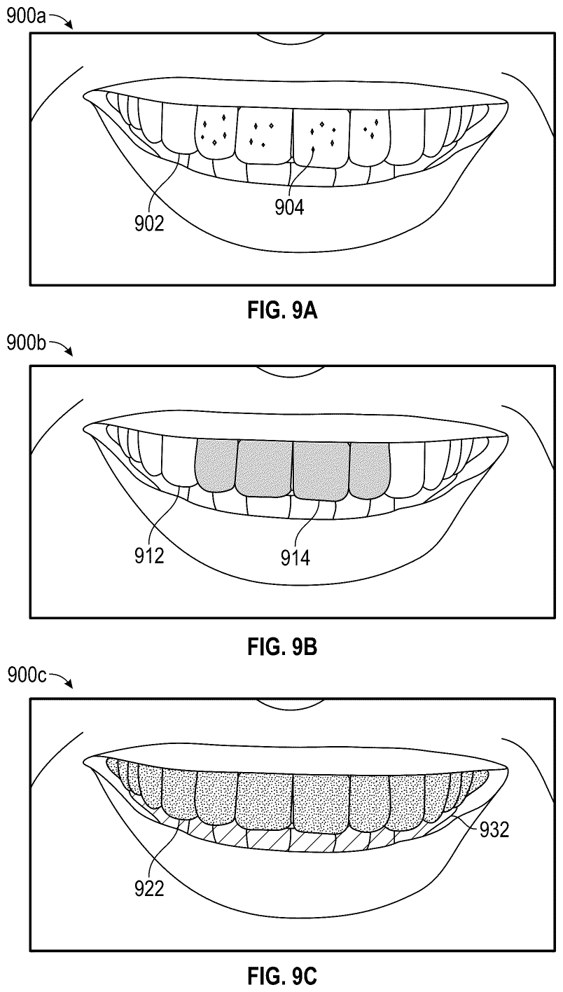

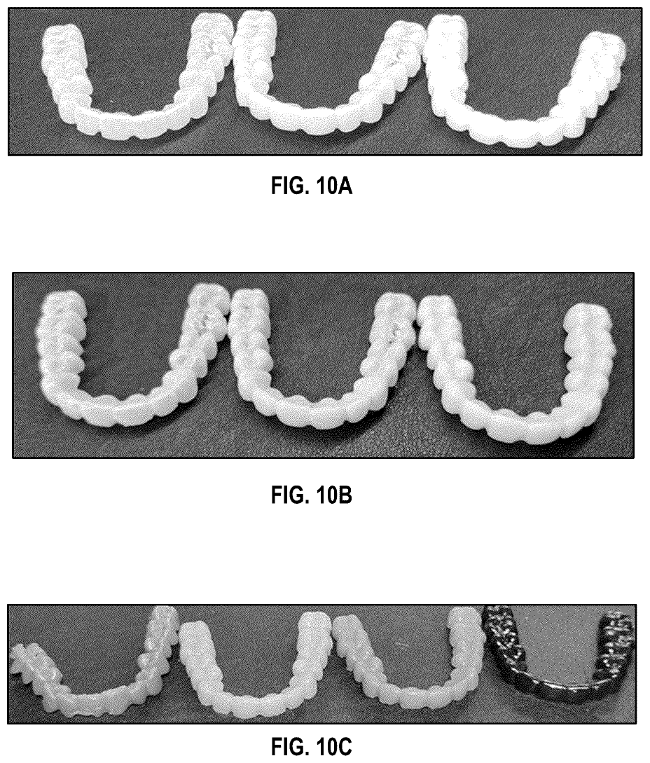

FIGS. 9A-10C illustrate representative examples of dental appliances with aesthetic features, in accordance with embodiments of the present technology. The dental appliances of FIGS. 9A-10C can be fabricated from any of the compositions and materials described herein.

FIG. 9A is a front view of a dental appliance 900a when the dental appliance 900a is worn by a patient, in accordance with embodiments of the present technology. The dental appliance 900a includes a shell 902 and a plurality of fillers 904 embedded in the shell 902, such as sparkles, glitter, bubbles, etc. In the illustrated embodiment, the fillers 904 are localized to the anterior teeth of the shell 902, e.g., to the central and lateral incisors. In other embodiments, however, the fillers 904 can alternatively or additionally be present in other portions of the shell 902, or can be present throughout the entire shell 902.

FIG. 9B is a front view of a dental appliance 900b when the dental appliance 900b is worn by a patient, in accordance with embodiments of the present technology. The dental appliance 900b includes a shell 912 including a colored material 914. The colored material 914 can have a desired color, such as a color that mimics the natural color of the patient's teeth or provides a whitened color. The colored material 914 may be opaque or semi-opaque to cover the underlying teeth. In the illustrated embodiment, the colored material 914 is localized to the anterior teeth of the shell 912, e.g., to the central and lateral incisors. The remaining portions of the shell 912 may be non-colored and/or transparent. In other embodiments, however, the colored material 914 can alternatively or additionally be present in other portions of the shell 912, or can be present throughout the entire shell 912 such that the entirety of the dental appliance 900b is colored.

FIG. 9C is a front view of a set 900c of dental appliances 922, 932 when the dental appliances 922, 932 are worn by a patient, in accordance with embodiments of the present technology. As shown in FIG. 9C, the set 900c can include a first dental appliance 922 configured to be worn on the upper teeth and a second dental appliance 932 configured to be worn on the lower teeth. In the illustrated embodiment, the first and second dental appliances 922, 932 have different aesthetic features, e.g., the first dental appliance 922 is composed of a uniformly colored material while the second dental appliance 932 is composed of a patterned material. In other embodiments, however, the first and second dental appliances 922, 932 can have the same aesthetic features, e.g., both appliances 922, 932 can have the same color, pattern, etc.

FIGS. 10A-10C are photographs of colored dental appliances, in accordance with embodiments of the present technology. Specifically, FIGS. 10A and 10B illustrate dental appliances having colors that mimic natural tooth colors, and FIG. 10C illustrates dental appliances having colors that differ from natural tooth colors.

Although certain embodiments of the materials provided herein are described primarily with reference to compositions for forming a shell and/or mask region of a dental appliance, in some embodiments, the materials herein may alternatively or additionally be provided as part of a coating on the dental appliance (which may or may not include a mask region, as noted above). The coating may contribute to structural, functional, and/or aesthetic aspects of the dental appliance, such as opacity, hardness, color, etc. Optionally, the structural, functional, and/or aesthetic aspects of a dental appliance may be substantially or entirely determined by the composition of the coating.

### II. Dental Appliances and Associated Methods

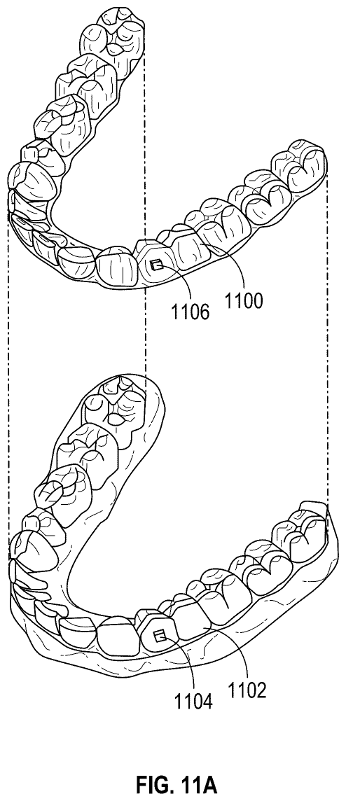

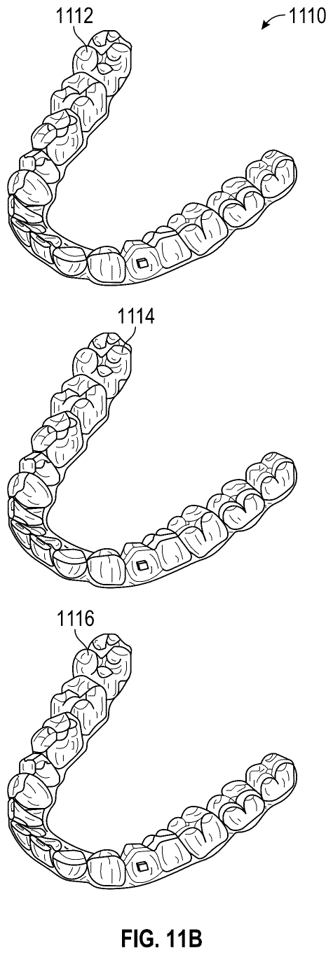

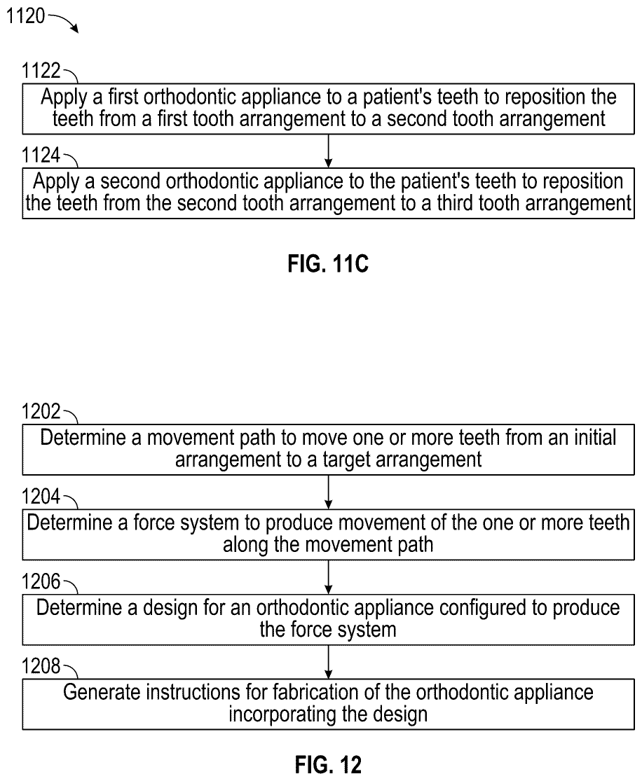

FIG. 11A illustrates a representative example of a tooth repositioning appliance 1100 configured in accordance with embodiments of the present technology. The appliance 1100 can be manufactured using any of the systems, methods, and devices described herein. The appliance 1100 (also referred to herein as an “aligner”) can be worn by a patient in order to achieve an incremental repositioning of individual teeth 1102 in the jaw. The appliance 1100 can include a shell (e.g., a continuous polymeric shell or a segmented shell) having teeth-receiving cavities that receive and resiliently reposition the teeth. The appliance 1100 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1100 can fit over all teeth present in an upper or lower jaw, or less than all of the teeth. The appliance 1100 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1100 can be a generic appliance configured to receive the teeth, but not necessarily shaped to match the topography of the patient's teeth. In some cases, only certain teeth received by the appliance 1100 are repositioned by the appliance 1100 while other teeth can provide a base or anchor region for holding the appliance 1100 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1100 in place over the teeth. In some cases, however, it may be desirable or necessary to provide individual attachments 1104 or other anchoring elements on teeth 1102 with corresponding receptacles 1106 or apertures in the appliance 1100 so that the appliance 1100 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 11B illustrates a tooth repositioning system 1110 including a plurality of appliances 1112, 1114, 1116, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1110 can include a first appliance 1112 corresponding to an initial tooth arrangement, one or more intermediate appliances 1114 corresponding to one or more intermediate arrangements, and a final appliance 1116 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 11C illustrates a method 1120 of orthodontic treatment using a plurality of appliances, in accordance with embodiments of the present technology. The method 1120 can be practiced using any of the appliances or appliance sets described herein. In block 1122, a first orthodontic appliance is applied to a patient's teeth in order to reposition the teeth from a first tooth arrangement to a second tooth arrangement. In block 1124, a second orthodontic appliance is applied to the patient's teeth in order to reposition the teeth from the second tooth arrangement to a third tooth arrangement. The method 1120 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 12 illustrates a method 1200 for designing an orthodontic appliance, in accordance with embodiments of the present technology. The method 1200 can be applied to any embodiment of the orthodontic appliances described herein. Some or all of the steps of the method 1200 can be performed by any suitable data processing system or device, e.g., one or more processors configured with suitable instructions.

In block 1202, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1204, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1204 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1206, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from AN SY S, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1208, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1200 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1200 may be performed with any suitable fabrication system or device, such as the embodiments described herein. Some of the steps may be optional, e.g., the process of block 1204 can be omitted, such that the orthodontic appliance is designed based on the desired tooth movements and/or determined tooth movement path, rather than based on a force system. Moreover, the order of the steps can be varied as desired.

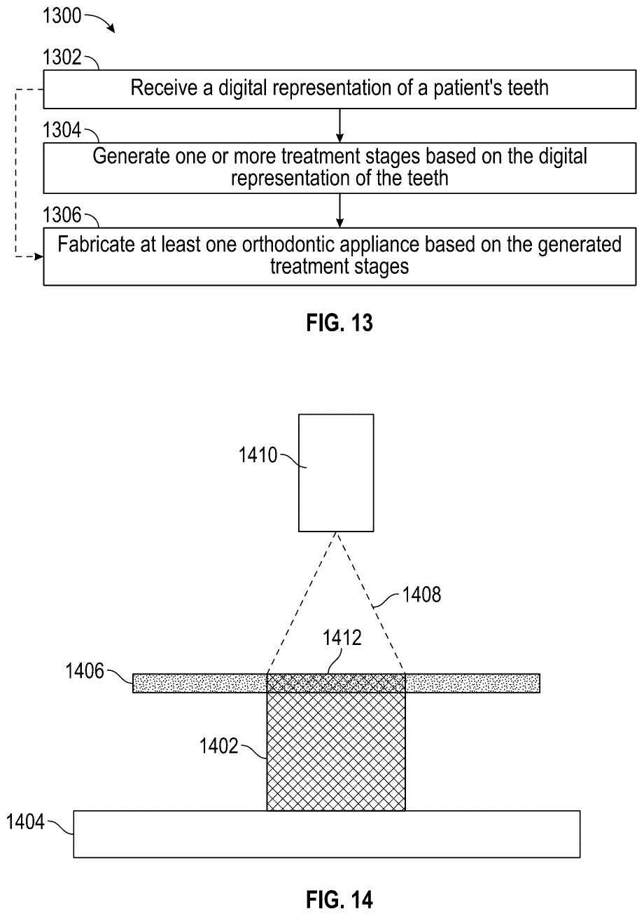

FIG. 13 illustrates a method 1300 for digitally planning an orthodontic treatment and/or design or fabrication of an appliance, in accordance with embodiments. The method 1300 can be applied to any of the treatment procedures described herein and can be performed by any suitable data processing system.

In block 1302, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1304, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1306, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 13, design and/or fabrication of an orthodontic appliance, and perhaps a particular orthodontic treatment, may include use of a representation of the patient's teeth (e.g., including receiving a digital representation of the patient's teeth (block 1302)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled, “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### III. Overview of Additive Manufacturing Technology

The dental appliances described herein, e.g., in Sections I and II above, can be fabricated using a wide variety of additive manufacturing techniques. Examples of additive manufacturing techniques that may be used include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform, such as using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DM LS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Pat. No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry (e.g., inkjet printing).

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. Nos. 6,749,414 and 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

FIG. 14 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards), including any of the embodiments described in Sections I and II above.

In some embodiments, additive manufacturing includes depositing a precursor material (e.g., a polymeric resin) onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

For example, in the embodiment of FIG. 14, an object 1402 is fabricated on a build platform 1404 from a series of cured material layers, with each layer having a geometry corresponding to a respective cross-section of the object 1402. To fabricate an individual object layer, a layer of curable material 1406 (e.g., polymerizable resin) is brought into contact with the build platform 1404 (when fabricating the first layer of the object 1402) or with the previously formed portion of the object 1402 on the build platform 1404 (when fabricating subsequent layers of the object 1402). In some embodiments, the curable material 1406 is formed on and supported by a substrate (not shown), such as a film. Energy 1408 (e.g., light) from an energy source 1410 (e.g., a laser, projector, or light engine) is then applied to the curable material 1406 to form a cured material layer 1412 on the build platform 1404 or on the object 1402. The remaining curable material 1406 can then be moved away from the build platform 1404 (e.g., by lowering the build platform 1404, by moving the build platform 1404 laterally, by raising the curable material 1406, and/or by moving the curable material 1406 laterally), thus leaving the cured material layer 1412 in place on the build platform 1404 and/or object 1402. The fabrication process can then be repeated with a fresh layer of curable material 1406 to build up the next layer of the object 1402.

The illustrated embodiment shows a “top down” configuration in which the energy source 1410 is positioned above and directs the energy 1408 down toward the build platform 1404, such that the object 1402 is formed on the upper surface of the build platform 1404. Accordingly, the build platform 1404 can be incrementally lowered relative to the energy source 1410 as successive layers of the object 1402 are formed. In other embodiments, however, the additive manufacturing process of FIG. 14 can be performed using a “bottom up” configuration in which the energy source 1410 is positioned below and directs the energy 1408 up toward the build platform 1404, such that the object 1402 is formed on the lower surface of the build platform 1404. Accordingly, the build platform 1404 can be incrementally raised relative to the energy source 1410 as successive layers of the object 1402 are formed.

Although FIG. 14 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

### EXAMPLES

The following examples are included to further describe some aspects of the present technology, and should not be used to limit the scope of the technology.

Example 1. A dental appliance comprising:
a shell comprising a plurality of cavities, the shell configured to reposition a patient's teeth from a first tooth arrangement toward a second tooth arrangement; and
a mask region integrally formed with the shell, wherein the mask region is configured to cover at least one tooth of the patient's teeth, and wherein the mask region depicts the at least one tooth according to a target tooth arrangement.

Example 2. The dental appliance of Example 1, wherein the at one tooth comprises one or more anterior teeth.

Example 3. The dental appliance of Example 1 or 2, wherein the plurality of cavities comprises at least one cavity configured to receive the at least one tooth, and the mask region comprises at least one tooth mask proximate to the at least one cavity.

Example 4. The dental appliance of Example 3, wherein the shell comprises an occlusal wall, a buccal wall, and a lingual wall that are each adjacent to the at least one cavity, and wherein the at least one tooth mask is connected to the buccal wall.

Example 5. The dental appliance of Example 4, wherein the at least one tooth mask comprises an occlusal portion that extends vertically above the occlusal wall of the shell.

Example 6. The dental appliance of Example 5, further comprising a smoothed ramp region connecting the occlusal portion of the at least one tooth mask and the occlusal wall of the shell.

Example 7. The dental appliance of any one of Examples 1 to 6, wherein the mask region comprises an occlusal portion and a gingival portion, the occlusal portion being thicker than the gingival portion.

Example 8. The dental appliance of any one of Examples 1 to 7, wherein the mask region comprises a mesial portion and a distal portion, the mesial portion being thicker than the distal portion.

Example 9. The dental appliance of any one of Examples 1 to 8, wherein the mask region is solid.

Example 10. The dental appliance of any one of Examples 1 to 8, wherein the mask region is hollow.

Example 11. The dental appliance of any one of Examples 1 to 10, wherein the at least one tooth comprises a plurality of teeth, and the mask region comprises an interproximal portion corresponding to an interproximal region of the plurality of teeth.

Example 12. The dental appliance of Example 11, wherein the interproximal portion of the mask region has a different color than a remaining portion of the mask region.

Example 13. The dental appliance of Example 11 or 12, wherein the interproximal portion comprises a groove configured to produce a shadowing effect.

Example 14. The dental appliance of Example 13, wherein the groove has a depth within a range from 50 μm to 5 mm.

Example 15. The dental appliance of any one of Examples 1 to 14, wherein the mask region is configured to cover an attachment on the at least one tooth.

Example 16. The dental appliance of Example 15, wherein the mask region comprises a recess configured to receive the attachment.

Example 17. The dental appliance of any one of Examples 1 to 16, wherein the mask region does not apply repositioning forces to the patient's teeth.

Example 18. The dental appliance of any one of Examples 1 to 17, wherein the shell comprises a first stiffness and the mask region comprises a second stiffness different from the first stiffness.

Example 19. The dental appliance of any one of Examples 1 to 18, wherein the shell comprises a first material and the mask region comprises a second material different from the first material.

Example 20. The dental appliance of any one of Examples 1 to 18, wherein the shell comprises a first material and the mask region comprises the first material.

Example 21. The dental appliance of any one of Examples 1 to 20, wherein the dental appliance comprises a material having a transmittance no greater than 80%.

Example 22. The dental appliance of any one of Examples 1 to 21, wherein the dental appliance comprises a colored material.

Example 23. The dental appliance of Example 22, wherein the colored material is configured to mimic coloration of the patient's teeth.

Example 24. The dental appliance of any one of Examples 1 to 23, wherein the dental appliance comprises a polymeric resin including at least one coloring agent.

Example 25. The dental appliance of Example 24, wherein the at least one coloring agent comprises a pigment, a dye, or a combination thereof.

Example 26. The dental appliance of Example 24 or 25, wherein the at least one coloring agent is present in the polymeric resin at a concentration within a range from 0.1 wt % to 1 wt %.

Example 27. The dental appliance of any one of Examples 24 to 26, wherein the polymeric resin comprises at least one light scattering filler.

Example 28. The dental appliance of any one of Examples 1 to 27, wherein the at least one tooth is in a first position in the second tooth arrangement and in a second position in the target tooth arrangement, the second position being different from the first position.

Example 29. The dental appliance of any one of Examples 1 to 28, wherein the target tooth arrangement corresponds to a final treatment stage of a treatment plan for repositioning the patient's teeth.

Example 30. The dental appliance of any one of Examples 1 to 29, wherein the dental appliance is an aligner.

Example 31. A method comprising directly fabricating the dental appliance of any one of Examples 1 to 30 using an additive manufacturing process.

Example 32. A method comprising applying the dental appliance of any one of Examples 1 to 30 to a patient's teeth.

Example 33. A method comprising:
receiving a treatment plan comprising a plurality of treatment stages, the plurality of treatment stages corresponding to a plurality of intermediate tooth arrangements for repositioning a patient's teeth;
receiving a digital representation of a target tooth arrangement for one or more teeth of the patient's teeth;
generating a digital representation of a dental appliance for implementing a treatment stage of the treatment plan, wherein the dental appliance includes a shell corresponding to the intermediate tooth arrangement of the treatment stage and a mask region corresponding to the target tooth arrangement; and
generating instructions for fabricating the dental appliance based on the digital representation, wherein the instructions are configured to cause the dental appliance to be fabricated with the mask region integrally formed with the shell.

Example 34. The method of Example 33, wherein the mask region is configured to cover at least one tooth of the patient's teeth.

Example 35. The method of Example 34, wherein the mask region depicts the at least one tooth according to the target tooth arrangement.

Example 36. The method of Example 34 or 35, wherein the shell comprises at least one cavity configured to receive the at least one tooth, and the mask region comprises at least one tooth mask proximate to the at least one cavity.

Example 37. The method of Example 36, wherein the shell comprises an occlusal wall, a buccal wall, and a lingual wall that are each adjacent to the at least one cavity, and wherein the at least one tooth mask is connected to the buccal wall.

Example 38. The method of Example 37, wherein the at least one tooth mask comprises an occlusal portion that extends vertically above the occlusal wall of the shell.

Example 39. The method of Example 38, wherein the dental appliance further comprises a smoothed ramp region connecting the occlusal portion of the at least one tooth mask and the occlusal wall of the shell.

Example 40. The method of any one of Examples 34 to 39, wherein the at least one tooth comprises a plurality of teeth, and the mask region comprises an interproximal portion corresponding to an interproximal region of the plurality of teeth.

Example 41. The method of Example 40, wherein the interproximal portion comprises a groove configured to produce a shadowing effect, a different color than a remaining portion of the mask region, or a combination thereof.

Example 42. The method of any one of Examples 34 to 41, wherein the at least one tooth is in a first position in the intermediate tooth arrangement and in a second position in the target tooth arrangement, the second position being different from the first position.

Example 43. The method of any one of Examples 33 to 42, wherein the mask region comprises an occlusal portion and a gingival portion, the occlusal portion being thicker than the gingival portion.

Example 44. The method of any one of Examples 33 to 43, wherein the mask region comprises a mesial portion and a distal portion, the mesial portion being thicker than the distal portion.

Example 45. The method of any one of Examples 33 to 44, wherein the digital representation is generated by:
receiving a first digital representation of the shell,
receiving a second digital representation of the mask region, and
combining the first digital representation and the second digital representation to produce the digital representation of the dental appliance.

Example 46. The method of Example 45, wherein the first digital representation is based on the intermediate tooth arrangement, and the second digital representation is based on the target tooth arrangement.

Example 47. The method of Example 45 or 46, wherein the second digital representation is generated by:
identifying at least one tooth in the intermediate tooth arrangement to be covered by the mask region, and
extracting a section of the digital representation of the target tooth arrangement corresponding to the at least one tooth.

Example 48. The method of Example 47, further comprising increasing a depth of an interproximal portion of the section corresponding to the at least one tooth.

Example 49. The method of any one of Examples 45 to 48, wherein the combining comprises overlaying the first digital representation and the second digital representation.

Example 50. The method of any one of Examples 45 to 49, wherein the combining comprises creating a smooth transition between the first digital representation and the second digital representation.

Example 51. The method of any one of Examples 33 to 50, wherein the instructions are configured to cause direct fabrication of the dental appliance using an additive manufacturing technique.

Example 52. The method of Example 51, wherein the additive manufacturing technique comprises one or more of: vat photopolymerization, material jetting, binder jetting, material extrusion, powder bed fusion, sheet lamination, or directed energy deposition.

Example 53. The method of any one of Examples 33 to 52, wherein the instructions are configured to cause fabrication of the dental appliance from a material having a transmittance no greater than 80%.

Example 54. The method of any one of Examples 33 to 53, wherein the instructions are configured to cause fabrication of the dental appliance from a colored material.

Example 55. The method of Example 54, wherein the colored material is configured to mimic coloration of the patient's teeth.

Example 56. The method of any one of Examples 33 to 55, wherein the instructions are configured to cause fabrication of the dental appliance from a polymeric resin including at least one coloring agent.

Example 57. The method of Example 56, wherein the at least one coloring agent comprises a pigment, a dye, or a combination thereof.

Example 58. The method of Example 56 or 57, wherein the at least one coloring agent is present in the polymeric resin at a concentration within a range from 0.1 wt % to 1 wt %.

Example 59. The method of any one of Examples 56 to 58, wherein the polymeric resin comprises at least one light scattering filler.

Example 60. The method of any one of Examples 33 to 59, wherein the target tooth arrangement corresponds to a final treatment stage of the treatment plan.

Example 61. The method of any one of Examples 33 to 60, wherein the dental appliance is an aligner.

Example 62. The method any one of Examples 33 to 61, further comprising fabricating the dental appliance based on the instructions.

Example 63. A system comprising:
one or more processors; and
a memory operably coupled to the one or more processors and storing instructions that, when executed by the one or more processors, cause the system to perform operations comprising the method of any one of Examples 33 to 62.

Example 64. A non-transitory computer-readable storage medium comprising instructions that, when executed by one or more processors of a computing system, cause the computing system to perform operations comprising the method of any one of Examples 33 to 62.

### CONCLUSION

Although many of the embodiments are described above with respect to systems, devices, and methods for fabricating dental appliances with aesthetic features, the technology is applicable to other applications and/or other approaches, such as fabrication of other types of objects where aesthetic features are desired. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-14.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A dental appliance comprising:
a shell comprising a plurality of cavities, the shell configured to reposition a patient's teeth from a first tooth arrangement toward a second tooth arrangement; and
a mask region integrally formed with the shell, wherein the mask region is configured to cover at least one tooth of the patient's teeth, and wherein the mask region depicts the at least one tooth according to a target tooth arrangement.

2. The dental appliance of claim 1, wherein the at least one tooth comprises one or more anterior teeth.

3. The dental appliance of claim 1, wherein the plurality of cavities comprises at least one cavity configured to receive the at least one tooth, and the mask region comprises at least one tooth mask proximate to the at least one cavity.

4. The dental appliance of claim 3, wherein the shell comprises an occlusal wall, a buccal wall, and a lingual wall that are each adjacent to the at least one cavity, and wherein the at least one tooth mask is connected to the buccal wall.

5. The dental appliance of claim 4, wherein the at least one tooth mask comprises an occlusal portion that extends vertically above the occlusal wall of the shell.

6. The dental appliance of claim 5, further comprising a smoothed ramp region connecting the occlusal portion of the at least one tooth mask and the occlusal wall of the shell.

7. The dental appliance of claim 1, wherein the mask region comprises an occlusal portion and a gingival portion, the occlusal portion being thicker than the gingival portion.

8. The dental appliance of claim 1, wherein the mask region comprises a mesial portion and a distal portion, the mesial portion being thicker than the distal portion.

9. The dental appliance of claim 1, wherein the mask region is solid.

10. The dental appliance of claim 1, wherein the mask region is hollow.

11. The dental appliance of claim 1, wherein the at least one tooth comprises a plurality of teeth, and the mask region comprises an interproximal portion corresponding to an interproximal region of the plurality of teeth.

12. The dental appliance of claim 11, wherein the interproximal portion of the mask region has a different color than a remaining portion of the mask region.

13. The dental appliance of claim 11, wherein the interproximal portion comprises a groove configured to produce a shadowing effect.

14. The dental appliance of claim 1, wherein the mask region is configured to cover an attachment on the at least one tooth.

15. The dental appliance of claim 14, wherein the mask region comprises a recess configured to receive the attachment.

16. The dental appliance of claim 1, wherein the mask region does not apply repositioning forces to the patient's teeth.

17. The dental appliance of claim 1, wherein the dental appliance comprises a material having a transmittance no greater than 80%.

18. The dental appliance of claim 1, wherein the at least one tooth is in a first position in the second tooth arrangement and in a second position in the target tooth arrangement, the second position being different from the first position.

19. The dental appliance of claim 1, wherein the target tooth arrangement corresponds to a final treatment stage of a treatment plan for repositioning the patient's teeth.

20. The dental appliance of claim 1, wherein the dental appliance is an aligner.
